(19) United States
(12) Patent Application Publication
(10) Pub. No.: US 2026/0337095 A1
(43) Pub. Date: Oct. 29, 2026

(54) APPARATUS FOR MANUFACTURING WINDOW AND METHOD FOR MANUFACTURING WINDOW BY USING THE SAME

(71) Applicant: Samsung Display Co., LTD., Yongin-si (KR)

(72) Inventors: HYUNCHUL KIM, Yongin-si (KR); JUNHEE BAE, Yongin-si (KR); BEOMSOO KIM, Yongin-si (KR); Seong Hwan KIM, Yongin-si (KR); SEUNGJUN LEE, Yongin-si (KR); JAE HOON JEONG, Yongin-si (KR); KANG DUK CHOI, Yongin-si (KR); SEUNGPYO HONG, Yongin-si (KR)

(21) Appl. No.: 19/564,721

(22) Filed: Mar. 12, 2026

(30) Foreign Application Priority Data
Apr. 25, 2025 (KR) 10-2025-0054834

(51) Int. Cl. C03C 15/00

(52) U.S. Cl. CPC C03C 15/00; C03C 2218/34

(57) ABSTRACT

An apparatus for manufacturing a window includes a fixed jig including a seat surface on which a preliminary glass is disposed, and a masking jig disposed on the fixed jig, and including a first sub mask and a second sub mask spaced apart from each other in a first direction. Each of the first sub mask and the second sub mask includes a flat jig portion having a flat surface facing the seat surface, and a slope jig portion extending from the flat surface, and having a slope surface, where a distance of the slope surface from the seat surface increases in a direction away from the flat surface. The flat jig portion includes a first liquid supply tube disposed thereinside, and a plurality of first holes connected to the first liquid supply tube, and opened in a direction toward the flat surface.

### CROSS-REFERENCE TO RELATED APPLICATION

This application claims priority to Korean Patent Application No. 10-2025-0054834, filed on Apr. 25, 2025, and all the benefits accruing therefrom under 35 U.S.C. §119, the content of which in its entirety is herein incorporated by reference.

### BACKGROUND

### 1. Field

The present disclosure herein relates to an apparatus for manufacturing a window and a method for manufacturing a window, and more particularly, to an apparatus for manufacturing a glass window including a partially slimmed region and a method for manufacturing a window by using the apparatus.

### 2. Description of the Related Art

In order to provide visual information, an electronic device having various forms are widely used in various fields, and recently, electronic devices including a flexible display panel foldable or bendable are being developed. Unlike a rigid electronic device, the flexible electronic device may variously change a shape thereof such as being folded, rolled, or bent, and thus has a feature of being portable regardless of a screen size on which an image is displayed.

### SUMMARY

A flexible electronic device may be desired to include a window for protecting a display panel without interfering with a folding or bending operation. Accordingly, development on a method and an apparatus for manufacturing a window having good folding characteristics and an improved surface feature without affecting display quality may be desired.

The present disclosure provides a method and an apparatus for manufacturing a window having improved surface characteristics and durability.

In addition, the present disclosure also provides a method and an apparatus, for manufacturing a window, in or with which a window suppressing a whitening phenomenon occurring on a surface of the window, easily controlling a shape of a slimming region of the window, and having a gentle slope surface without an angled part may be manufactured.

An embodiment of the invention provides an apparatus for manufacturing a window including a fixed jig including a seat surface on which a preliminary glass is disposed, and a masking jig disposed on the fixed jig, and including a first sub mask and a second sub mask spaced apart from each other in a first direction, where each of the first sub mask and the second sub mask includes a flat jig portion having a flat surface facing the seat surface, and a slope jig portion extending from the flat surface, and having a slope surface, where a distance of the slope surface from the seat surface increases in a direction away from the flat surface, and the flat jig portion includes a first liquid supply tube disposed thereinside, and a plurality of first holes connected to the first liquid supply tube, and opened in a direction toward the flat surface.

In an embodiment, each of the plurality of first holes may have a diameter of about 0.1 µm or less.

In an embodiment, the plurality of first holes may be entirely disposed on the flat surface.

In an embodiment, the flat surface may include a first flat portion next to the slope surface and a second flat portion spaced apart from the slope surface, and a disposition number of the plurality of first holes per unit area in the first flat portion may be greater than a disposition number of the plurality of first holes per unit area in the second flat portion.

In an embodiment, the fixed jig may include a second liquid supply tube disposed thereinside, and a plurality of second holes connected to the second liquid supply tube, and opened in a direction toward the seat surface.

In an embodiment, the slope jig portion may include a third liquid supply tube disposed thereinside, and a plurality of third holes connected to the third liquid supply tube, and opened in a direction toward the slope surface.

In an embodiment, the slope surface may be a slope plane without a discontinuous point, or a slope curved surface having a convex shape in a direction of the fixed jig.

In an embodiment, the preliminary glass may include a preliminary folding portion disposed on a lower side of the slope jig portion, and a preliminary non-folding portion disposed on a lower side of the flat jig portion, the preliminary folding portion may be processed to include a flat region, and a first slope region and a second slope region disposed spaced apart from each other in the first direction with the flat region therebetween, and widths in the first direction of the slope jig portions of the first sub mask and the second sub mask may respectively correspond to widths in the first direction of the first slope region and the second slope region in a folding portion formed by slimming-processing the preliminary glass.

In an embodiment, the masking jig and the fixed jig may each include a base portion having a hydrofluoric acid-resistant material and a magnet disposed in the base portion, and the masking jig and the fixed jig may be fixed in positions close to each other by the magnet with the preliminary glass therebetween.

In an embodiment, the apparatus for manufacturing a window may further include a liquid supply portion connected to the first liquid supply tube, and an etchant supply portion in which etchant is accommodated and the fixed jig and the masking jig are dipped.

In an embodiment of the invention, an apparatus for manufacturing a window includes a fixed jig, and a masking jig facing the fixed jig, and including a first sub mask and a second sub mask each including a flat surface and a slope surface, where a distance of the slope surface from the fixed jig increases in a direction away from the flat surface, and the first sub mask and the second sub mask are spaced apart from each other with a space therebetween, where the masking jig includes a first liquid supply tube disposed to overlap the flat surface, and a plurality of first holes connected to the first liquid supply tube, and opened in a direction toward the flat surface, and a method for manufacturing a window by using the apparatus for manufacturing a window includes disposing a preliminary glass on the fixed jig, moving the masking jig to fix the preliminary glass between the fixed jig and the masking jig, providing liquid through the plurality of first holes to form a first water film between the preliminary glass and the flat surface, providing etchant to the preliminary glass exposed on a lower side of the slope surface between the first sub mask and the second sub mask and the space, and etching the preliminary glass to form a glass window including a recessed portion defined as a flat region corresponding to the space between the first sub mask and the second sub mask and a slope region corresponding to the slope surface.

In an embodiment, the liquid may include ultrapure water.

In an embodiment, in the providing of the etchant to the preliminary glass, a concentration of the etchant may decrease in a direction away from the space between the first sub mask and the second sub mask to the flat surface.

In an embodiment, the flat surface may include a first flat portion next to the slope surface and a second flat portion spaced apart from the slope surface, and in the providing liquid through the plurality of first holes, a flow rate of the provided liquid per unit area in the first flat portion may be greater than a flow rate of the provided liquid per unit area in the second flat portion.

In an embodiment, the fixed jig may include a seat surface on which the preliminary glass is disposed, a second liquid supply tube disposed inside the fixed jig, and a plurality of second holes connected to the second liquid supply tube, and opened in a direction toward the seat surface, and the method for manufacturing a window may further include providing the liquid through the plurality of second holes to form a second water film between the preliminary glass and the seat surface, and the providing the liquid through the plurality of first holes and the providing the liquid through the plurality of second holes may be simultaneously performed.

In an embodiment, the masking jig may include a third liquid supply tube thereinside to overlap the slope surface, and a plurality of third holes connected to the third liquid supply tube, and opened in a direction toward the slope surface, the method for manufacturing a window may further include providing the liquid through the plurality of third holes to form a third water film between the preliminary glass and the slope surface, and wherein the providing the liquid through the plurality of first holes and the providing the liquid through the plurality of third holes may be simultaneously performed.

In an embodiment, in the providing the liquid through the plurality of first holes, the liquid may be supplied through a liquid supply portion connected to the first liquid supply tube.

In an embodiment, the method may further include removing the first water film.

In an embodiment, the plurality of first holes may be entirely disposed on the flat surface.

In an embodiment, each of the plurality of first holes may have a diameter of about 0.1 micrometer (µm) or less.

### BRIEF DESCRIPTION OF THE DRAWINGS

The above and other features of embodiments of the invention will become more apparent by describing in further detail embodiments thereof with reference to the accompanying drawings, in which:

FIG. 1A is a block diagram of an electronic device according to an embodiment;

FIG. 1B is schematic diagrams of electronic devices according to various embodiments;

FIG. 2A is a perspective view illustrating a state in which an electronic device according to an embodiment is unfolded;

FIG. 2B is a perspective view illustrating in-folding of an electronic device according to an embodiment illustrated in FIG. 2A;

FIG. 2C is a perspective view illustrating out-folding of an electronic device according to an embodiment illustrated in FIG. 2A;

FIG. 3A is a perspective view illustrating a state in which an electronic device according to an embodiment is unfolded;

FIG. 3B is a perspective view illustrating in-folding of an electronic device according to an embodiment illustrated in FIG. 3A;

FIG. 3C is a perspective view illustrating out-folding of an electronic device according to an embodiment illustrated in FIG. 3A;

FIG. 4A is a perspective view of an electronic device according to an embodiment;

FIGS. 4B and 4C are perspective views of states in which an electronic device illustrated in FIG. 4A is multi-folded, respectively;

FIG. 5 is an exploded perspective view of an electronic device according to an embodiment;

FIG. 6 is a cross-sectional view of an electronic device according to an embodiment;

FIG. 7 is a cross-sectional view of a window according to an embodiment;

FIG. 8 is a perspective view of an apparatus for manufacturing a window according to an embodiment;

FIG. 9 is a cross-sectional view of an apparatus for manufacturing a window according to an embodiment;

FIG. 10A is a cross-sectional view of a part of an apparatus for manufacturing a window according to an embodiment;

FIG. 10B is a schematic diagram illustrating a shape of a processed window and a masking jig according to an embodiment;

FIG. 11 is a cross-sectional view of a part of an apparatus for manufacturing a window according to an embodiment;

FIG. 12 is a cross-sectional view of a part of an apparatus for manufacturing a window according to an embodiment;

FIG. 13 is a cross-sectional view of a part of an apparatus for manufacturing a window according to an embodiment;

FIG. 14 is a flowchart of a method for manufacturing a window according to an embodiment;

FIGS. 15A-15D are diagrams illustrating operations of a method for manufacturing a window according to an embodiment, respectively; and

FIGS. 16-18 are diagrams illustrating operations of a method for manufacturing a window according to an embodiment, respectively.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present therebetween. In contrast, when an element is referred to as being “directly on” another element, there are no intervening elements present.

In this specification, when a component (or region, layer, portion, etc.) is referred to as “connected”, or “coupled” to another component, it means that it is connected/coupled directly to the other component or a third component can be disposed therebetween.

The same reference numerals or symbols refer to the same elements. In addition, in the drawings, thicknesses, ratios, and dimensions of components are exaggerated for effective description of technical content.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

The terminology used herein is for the purpose of describing particular embodiments only and is not intended to be limiting. As used herein, "a", "an," "the," and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, "an element" has the same meaning as “at least one element," unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Meanwhile, in the disclosure, "one region/part corresponds to another region/part" means "overlap each other", and is not limited to the same area and/or the same shape. In addition, in the disclosure, "one region/part overlaps another region/part" means "overlap when seen on a plane", and includes "the indicated regions/parts at least partially overlap each other on the plane".

"About" or "approximately" as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, "about" can mean within one or more standard deviations, or within ± 30%, 20%, 10% or 5% of the stated value.

Unless otherwise defined, all terms (including technical and scientific terms) used in this specification have the same meaning as commonly understood by one of ordinary skill in the art to which this invention belongs. In addition, terms such as terms defined in commonly used dictionaries should be interpreted as having a meaning consistent with the meaning having in the context of the related technology, and should not be interpreted as too ideal or too formal unless explicitly defined here.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, an electronic device according to an embodiment, an apparatus for manufacturing a window according to an embodiment and a method for manufacturing a window according to an embodiment will be described with reference to the accompanying drawings.

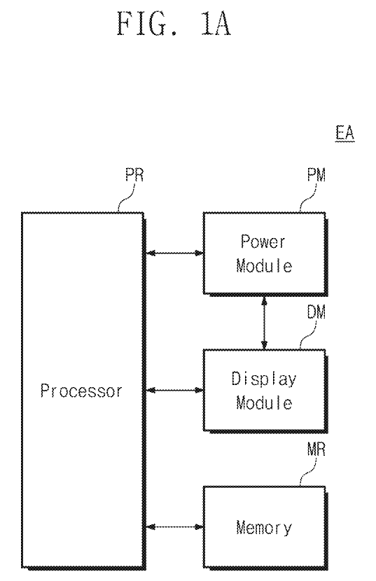

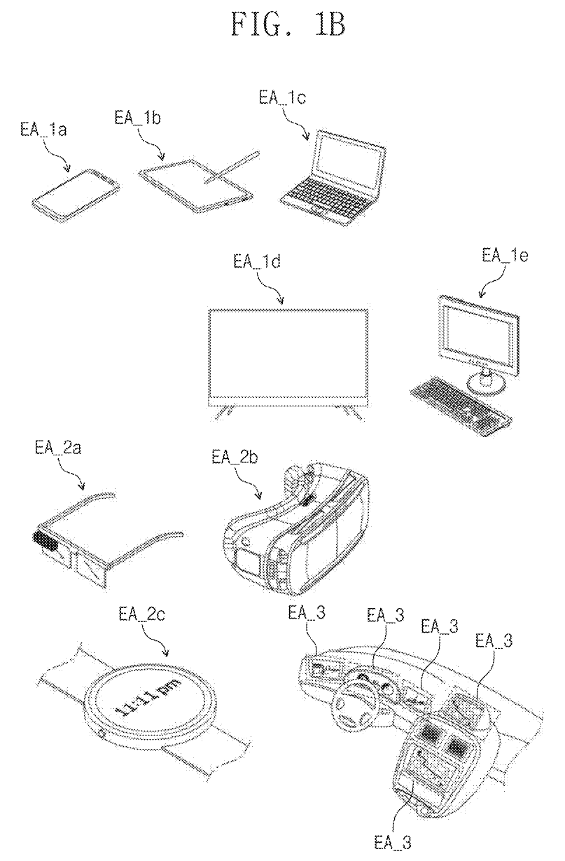

FIG. 1A is a block diagram of an electronic device according to an embodiment. Referring to FIG. 1A, an electronic device EA according to an embodiment may include a display module DM, a processor PR, a memory MR and a power module PM.

The processor PR may include at least one selected from a central processing unit (CPU), an application processor (AP), a graphic processing unit (GPU), a communication processor (CP), an image signal processor (ISP), or a controller.

Data information necessary for an operation of the processor PR or the display module DM may be stored in the memory MR. When the processor PR performs an application stored in the memory MR, an image data signal and/or an input control signal may be transferred to the display module DM, and the display module DM may process the provided signal to output image information through the display screen.

The power module PM may include a power supply module such as a power adapter or a battery device, and a power transformation module that transforms power supplied by the power supply module and that generates power used for an operation of the electronic device EA.

At least one of each component of the electronic device EA described above may be included in a display device according to an embodiment. In addition, some of separate modules functionally included in one module may be included in the display device, and others may be provided to be separated from the display device. In an embodiment, for example, the display device may include the display module DM according to an embodiment to be described later. The processor PR, the memory MR and the power module PM may be provided in a form of another unit in the electronic device EA not in the display device.

FIG. 1B is schematic diagrams of electronic devices according to various embodiments.

Referring to FIG. 1B, various electronic devices in which the display device according to an embodiment is applied may include not only an electronic device for displaying an image such as a smart phone EA_1a, a tablet computer EA_1b, a laptop computer EA_1c, a television (TV) EA_1d and a monitor for a desk EA_1e, but also a wearable electronic device including a display module such as a smart glasses EA_2a, a head mount display EA_2b, and a smart watch EA_2c, and an electronic device for a vehicle EA_3 including a display module such as a center information display (CID) and a room mirror display disposed on an instrument cluster, a center fascia and a dashboard of a car.

The display device according to an embodiment may be applied to various electronic devices. The electronic device according to an embodiment may further include a module or a unit having another additional function in addition to the display device.

The electronic device according to an embodiment is illustrated in FIGS. 1A-5, and the electronic device according to an embodiment illustrated in FIGS. 1A-5 includes a glass window manufactured in a method for manufacturing a window according to an embodiment and with an apparatus for manufacturing a window according to an embodiment to be described later. The glass window manufactured in the method for manufacturing a window according to an embodiment and with the apparatus for manufacturing a window according to an embodiment may be referred to as a window.

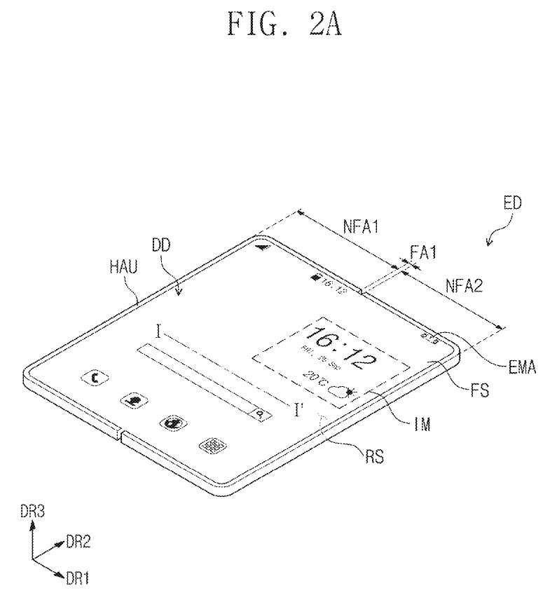

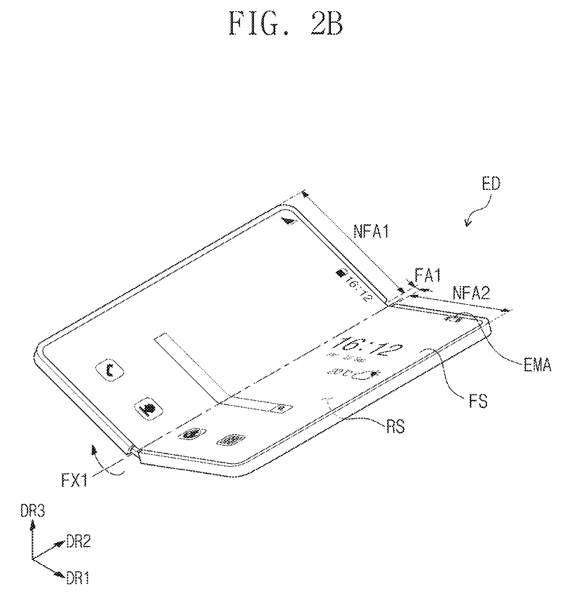

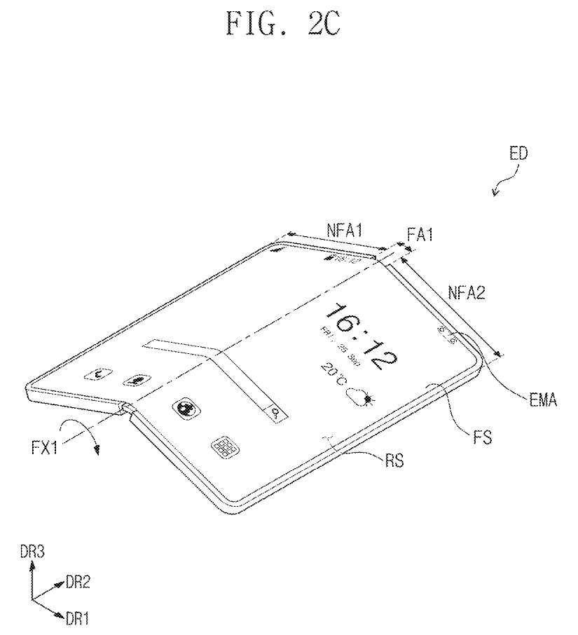

FIG. 2A is a perspective view illustrating a state in which an electronic device according to an embodiment is unfolded. FIG. 2B is a perspective view illustrating in-folding of the electronic device illustrated in FIG. 2A. FIG. 2C is a perspective view illustrating out-folding of the electronic device illustrated in FIG. 2A.

An electronic device ED according to an embodiment may be activated in response to an electrical signal. In an embodiment, for example, the electronic device ED may be a portable phone, a tablet computer, a car navigation system, a game console or a wearable device, but an embodiment of the invention is not limited thereto. For convenience of illustration and description, embodiments where the electronic device ED is a portable phone are illustrated in FIG. 2A or the like as an example, but not being limited thereto.

Referring to FIGS. 2A -2C, the electronic device ED according to an embodiment may include a first display surface FS defined by a first directional axis DR1 and a second directional axis DR2 crossing the first directional axis DR1. The electronic device ED may provide an image IM to a user through the first display surface FS. The electronic device ED according to an embodiment may display the image IM on the first display surface FS parallel to each of the first directional axis DR1 and the second directional axis DR2 toward a third directional axis DR3. In the disclosure, a front surface (or upper surface) and a rear surface (or lower surface) of each component are defined with respect to a direction in which the image IM is displayed. The front surface and the rear surface may be opposed to each other in the third directional axis DR3, and a normal direction of each of the front surface and the rear surface may be parallel to the third directional axis DR3.

The electronic device ED according to an embodiment may include the first display surface FS and a second display surface RS. An electronic module region EMA may be included in the first display surface FS. The second display surface RS may be defined as a surface opposing at least a portion of the first display surface FS. That is, the second display surface RS may be defined as a portion of the rear surface of the electronic device ED.

The electronic device ED according to an embodiment may sense an external input applied from an outside thereof. The external input may include various forms of inputs provided by the outside thereof. In an embodiment, for example, the external input may include not only a contact by a part of a user's body such as a user’s hand, but also an external input (for example, hovering) applied proximate or adjacent to the electronic device ED within a predetermined distance. In addition, the external input may have various forms such as a force, pressure, temperature, and light.

The first directional axis DR1 to the third directional axis DR3 are illustrated in FIG. 2A and the consecutive drawings, and directions indicated by the first to third directional axes DR1, DR2, and DR3 described in the disclosure are relative concepts and may thus be changed into other directions. In addition, the directions indicated by the first to third directional axes DR1, DR2, and DR3 may be referred to as first to third directions, and the same reference symbols may be used. Here, the third direction DR3 may be a thickness direction.

The first display surface FS of the electronic device ED may include an active region, which is activated in response to an electrical signal. The electronic device ED according to an embodiment may display the image IM through the first display surface FS. In addition, the electronic device ED according to an embodiment may sense various forms of the external input on the first display surface FS.

The electronic device ED may include a folding region FA1 and non-folding regions NFA1 and NFA2. According to an embodiment, the non-folding regions NFA1 and NFA2 may be disposed adjacent to the folding region FA1 with the folding region FA1 therebetween. The electronic device ED according to an embodiment may include a first non-folding region NFA1 and a second non-folding region NFA2 disposed spaced apart from each other in the first directional axis DR1 with the folding region FA1 therebetween. In an embodiment, for example, the first non-folding region NFA1 may be disposed on one side of the folding region FA1 along the first directional axis DR1, and the second non-folding region NFA2 may be disposed on an opposing other side of the folding region FA1 along the first directional axis DR1.

FIGS. 2A-2C illustrate an embodiment of the electronic device ED including a single folding region FA1, but an embodiment of the invention is not limited thereto, and a plurality of folding regions may be defined in the electronic device ED. In another embodiment, for example, the electronic device according to an embodiment may include at least two folding regions and at least three non-folding regions disposed with each of the folding regions therebetween.

Referring to FIG. 2B, the electronic device ED according to an embodiment may be folded with respect to a first folding axis FX1. The first folding axis FX1 may be parallel to a long side direction of the electronic device ED as an imaginary axis extending in the second directional axis DR2. The first folding axis FX1 may extend on the first display surface FS along the second directional axis DR2.

The electronic device ED may be folded with respect to the first folding axis FX1 to be transformed into an in-folded state in which one region overlapping the first non-folding region NFA1 of the first display surface FS and the other region overlapping the second non-folding region NFA2 face each other.

In such an embodiment, a user may see the second display surface RS in the in-folded state of the electronic device ED. The second display surface RS may further include an electronic module region in which an electronic module including various components is disposed, and is not limited to any one embodiment.

Referring to FIG. 2C, the electronic device ED according to an embodiment may be folded with respect to the first folding axis FX1 to be transformed into an out-folded state in which one region overlapping the first non-folding region NFA1 of the second display surface RS and the other region overlapping the second non-folding region NFA2 face each other.

However, an embodiment of the invention is not limited thereto, and the electronic device ED according to an embodiment may be folded with respect to a plurality of folding axes such that each of the first display surface FS and the second display surface RS partially face each other. A number of the folding axis and a number of the non-folding region according thereto are not specially limited.

Various electronic modules may be disposed in the electronic module region EMA. In an embodiment, for example, the electronic module may include at least one selected from a camera, a speaker, an optical sensor or a thermal sensor. The electronic module region EMA may sense an external object through the first or second display surface FS or RS, or may provide a sound signal such as a voice to the outside through the first or second display surface FS or RS. The electronic module may include a plurality of components, and is not limited to any one embodiment.

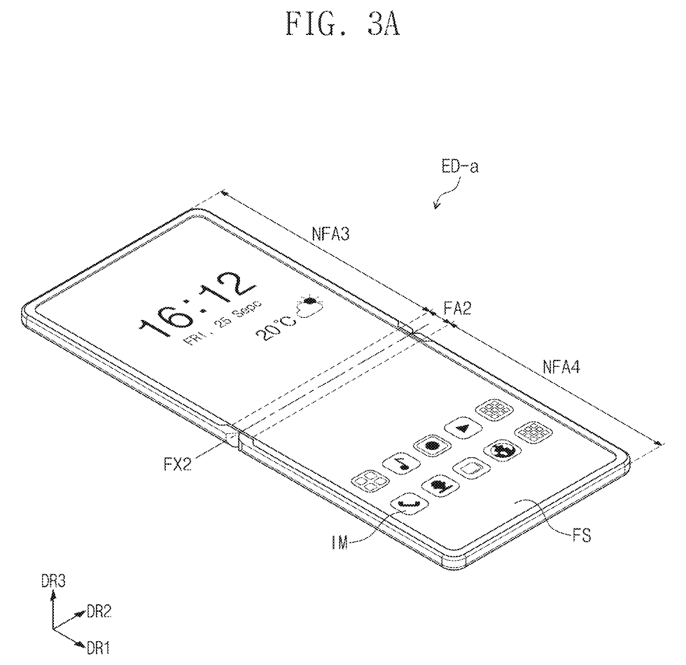

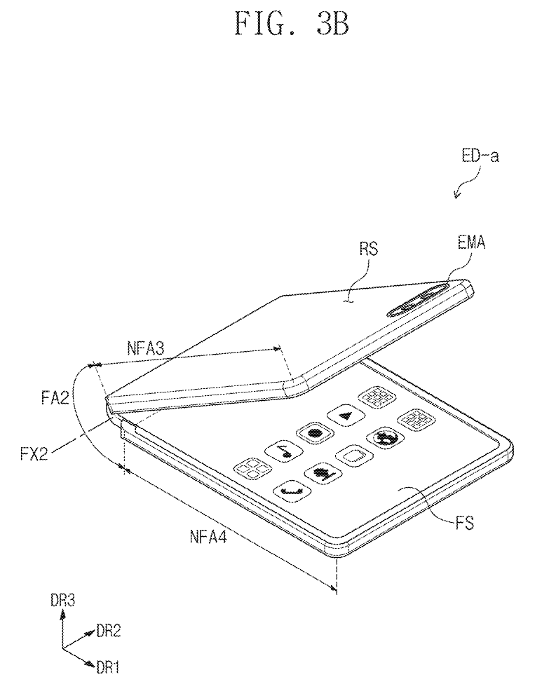

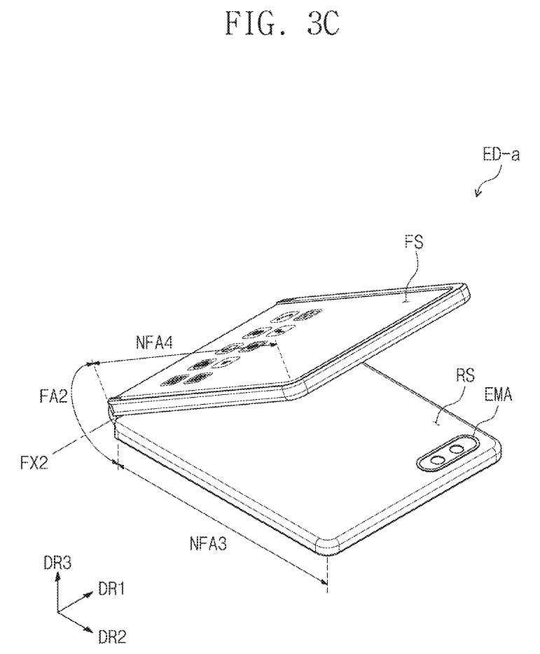

FIG. 3A is a perspective view illustrating a state in which an electronic device according to an embodiment is unfolded. FIG. 3B is a perspective view illustrating in-folding of the electronic device illustrated in FIG. 3A. FIG. 3C is a perspective view illustrating out-folding of the electronic device illustrated in FIG. 3A.

An electronic device ED-a according to an embodiment may be folded with respect to a second folding axis FX2 extending in one direction parallel to the second directional axis DR2. FIG. 3B illustrates an embodiment in which an extension direction of the second folding axis FX2 is parallel to an extension direction of a short side of the electronic device ED-a. However, an embodiment of the invention is not limited thereto.

The electronic device ED-a according to an embodiment may include at least one folding region FA2 and non-folding regions NFA3 and NFA4 adjacent to the folding region FA2. The non-folding regions NFA3 and NFA4 may be disposed spaced apart from each other with the folding region FA2 therebetween.

The folding region FA2 has a predetermined curvature and a predetermined radius of curvature. In an embodiment, the first non-folding region NFA3 and the second non-folding region NFA4 may face each other, and the electronic device ED-a may be in-folded such that the display surface FS is not exposed to the outside. In addition, referring to FIG. 3C, the electronic device ED-a according to an embodiment may be out-folded such that the first display surface FS is exposed to the outside.

The electronic device ED-a according to an embodiment may include the second display surface RS, and the second display surface RS may be defined as a surface at least partially opposing the first display surface FS. The second display surface RS may include the electronic module region EMA on which an electronic module including various components is disposed. In addition, an image or video may be displayed on at least a portion of the second display surface RS.

In a non-folded state of the electronic device ED-a according to an embodiment, a user may see the first display surface FS, and in the in-folded state of the electronic device ED-a according to an embodiment, a user may see the second display surface RS.

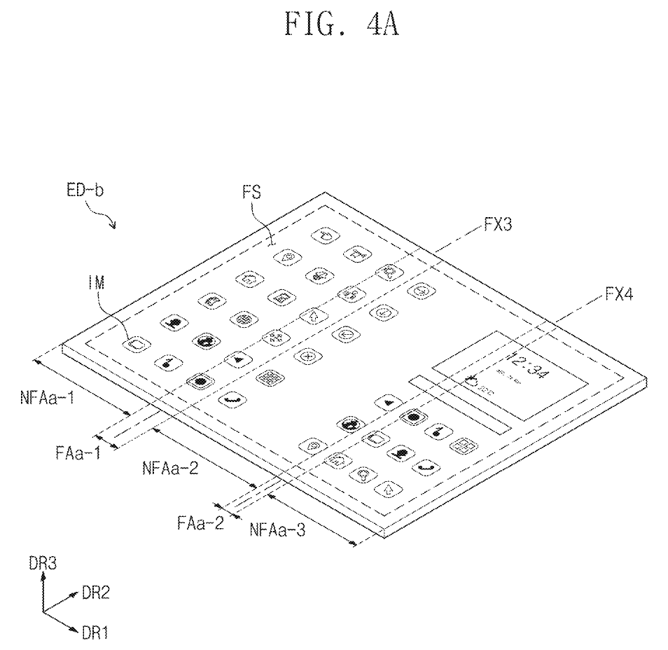

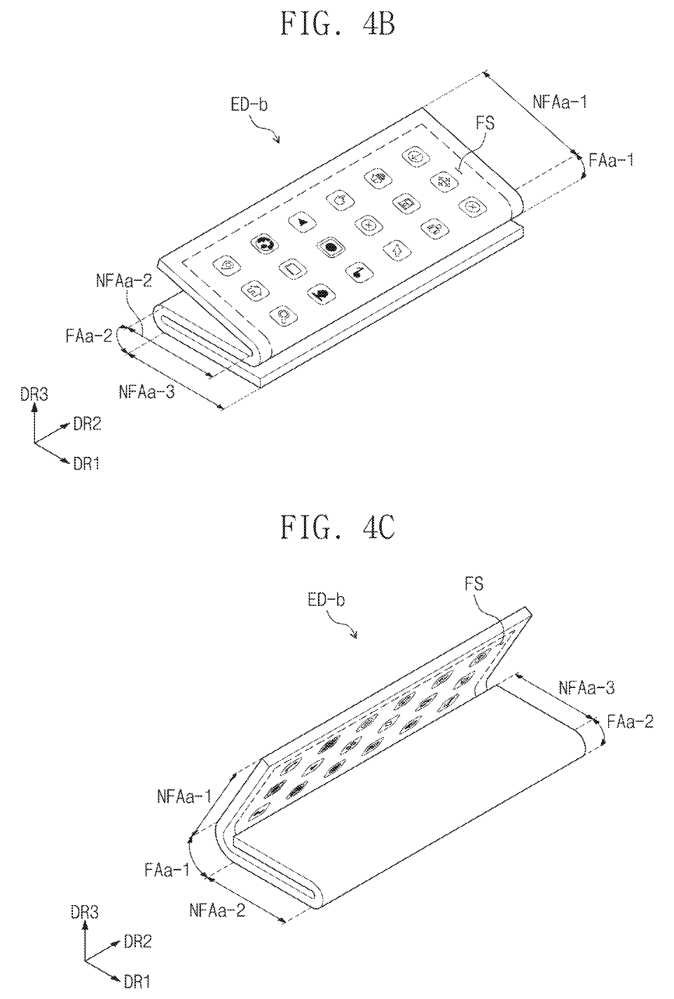

FIG. 4A is a perspective view illustrating a state in which an electronic device ED-b according to an embodiment is unfolded. FIGS. 4B and 4C are perspective views of states in which an electronic device ED-b illustrated in FIG. 4A is multi-folded, respectively.

Referring to FIGS. 4A-4C, the electronic device ED-b according to an embodiment may be a multi-foldable device including a plurality of folding regions. The electronic device ED-b may include a plurality of folding regions FAa-1 and FAa-2 and a plurality of non-folding regions NFAa-1, NFAa-2 and NFAa-3. The electronic device ED-b according to an embodiment may include a first folding region FAa-1, a second folding region FAa-2, a first non-folding region NFAa-1, a second non-folding region NFAa-2 and a third non-folding region NFAa-3. In the first directional axis DR1, the first folding region FAa-1 is disposed between the first non-folding region NFAa-1 and the second non-folding region NFAa-2, and the second folding region FAa-2 is disposed between the second non-folding region NFAa-2 and the third non-folding region NFAa-3. FIGS. 4A-4C illustrate an embodiment including two folding regions FAa-1 and FAa-2 and three non-folding regions NFAa-1, NFAa-2 and NFAa-3 as an example, but numbers of the folding regions FAa-1 and FAa-2 and the non-folding regions NFAa-1, NFAa-2 and NFAa-3 are not limited thereto, and may be further increased.

Referring to FIGS. 4A and 4B, the first folding region FAa-1 may be folded with respect to a third folding axis FX3 parallel to the second directional axis DR2. The first folding region FAa-1 may be out-folded such that a rear surface of the second non-folding region NFAa-2 faces a rear surface of the first non-folding region NFAa-1, and such that a display surface of the first non-folding region NFAa-1 faces the outside. The second folding region FAa-2 may be folded with respect to a fourth folding axis FX4 parallel to the second directional axis DR2. The second folding region FAa-2 may be in-folded such that a display surface of the second non-folding region NFAa-2 and a display surface of the third non-folding region NFAa-3 face each other.

Referring to FIGS. 4A and 4C, the second folding region FAa-2 may be folded with respect to the fourth folding axis FX4 parallel to the second directional axis DR2. The electronic device ED-b according to an embodiment may be in-folded such that the display surface of the second non-folding region NFAa-2 may be disposed inside, and such that the display surface of the second non-folding region NFAa-2 and the display surface of the third non-folding region NFAa-3 face each other. The first folding region FAa-1 may be folded with respect to the third folding axis FX3 parallel to the second directional axis DR2. The electronic device ED-b according to an embodiment may be in-folded such that the rear surface of the third non-folding region NFAa-3 and the display surface of the first non-folding region NFAa-1 face each other.

The multi-folded state is not limited to those illustrated in FIGS. 4B and 4C, and various folding forms may be present.

According to an embodiment of the invention, the out-folding operation and the in-folding operation may simultaneously occur, and only any one operation of the out-folding operation and the in-folding operation may occur.

The electronic device ED, ED-a, or ED-b according to an embodiment may be constituted to mutually repeat the in-folding operation or the out-folding operation from the unfolding operation, but an embodiment of the invention is not limited thereto. The electronic device ED, ED-a, or ED-b according to an embodiment may be constituted to select any one among the unfolding operation, the in-folding operation and the out-folding operation. In addition, when the electronic device ED, ED-a, or ED-b according to an embodiment includes a plurality of folding regions, folding directions of at least one of the plurality of folding regions may be different from folding directions of the other folding regions. For example, when the electronic device ED, ED-a, or ED-b according to an embodiment includes two folding regions, two non-folding regions with one folding region therebetween may be folded in the in-folding operation, and two non-folding regions with the other folding region therebetween may be folded in the out-folding operation.

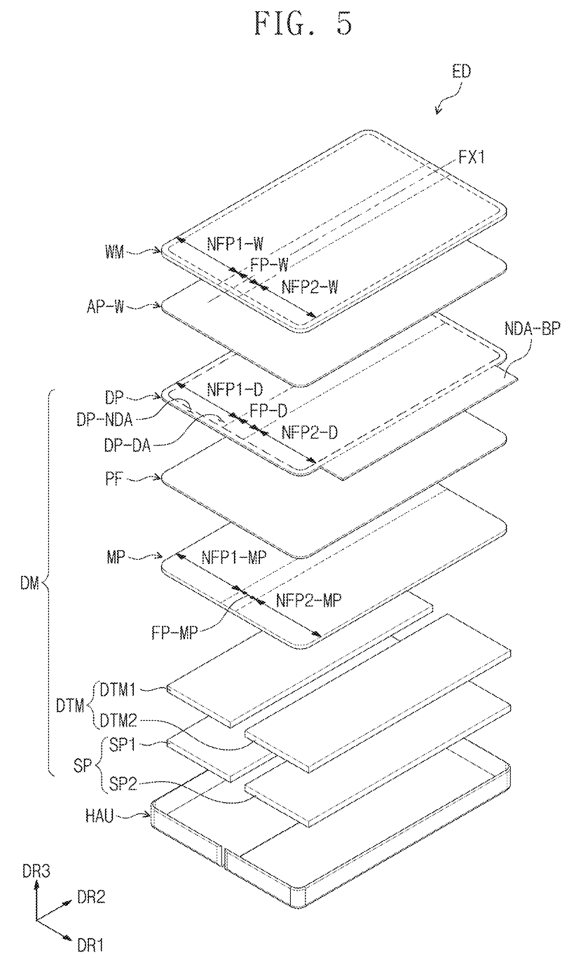

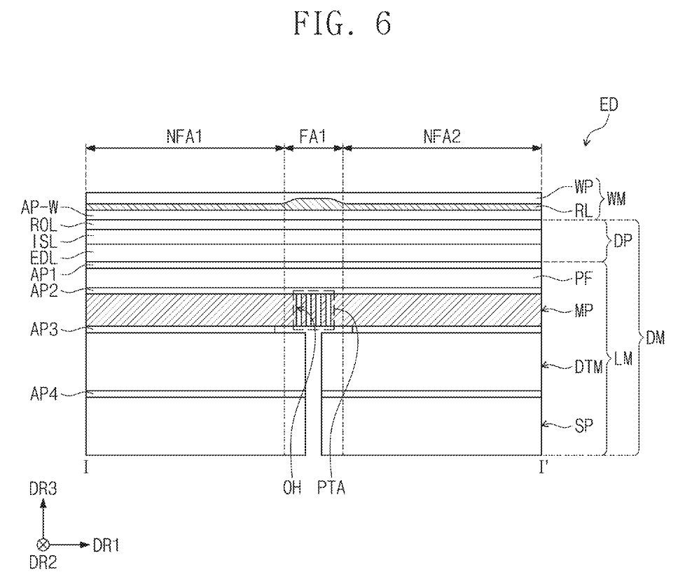

FIG. 5 is an exploded perspective view of an electronic device according to an embodiment. FIG. 6 is a cross-sectional view illustrating a part of the electronic device according to an embodiment. FIG. 6 is a cross-sectional view illustrating a part taken along line I-I’ of FIG. 2A.

FIGS. 5, 6 and the like illustrate an embodiment of the electronic device ED illustrated in FIG. 2A and the like, in which the folding axis FX1 is parallel to a long side of the electronic device ED, but an embodiment of the invention is not limited thereto, and description provided above with reference to the following drawings may be applied to an electronic device in which the folding axis FX2 is parallel to a short side of the electronic device as illustrated in FIG. 3A and the like, or an electronic device multi-folded as illustrated in FIG. 4A and the like.

The electronic device ED according to an embodiment may include the display module DM, a window module WM and a housing HAU that accommodates the display module DM and the window module WM.

The display module DM may include a display panel DP and a lower module LM disposed on a lower side of the display panel DP. The lower module LM may include a support plate MP. In addition, the lower module LM may further include at least one selected from a protective layer PF, a support member SP, adhesive layers AP1, AP2, AP3 and AP4 or a digitizer module DTM, in addition to the support plate MP.

The display panel DP may display an image (e.g., a video) in response to an electrical signal, and may receive/send information about an external input. The display panel DP may include a display region DP-DA and a non-display region DP-NDA. The display region DP-DA may be defined as a region that displays the image provided by the display panel DP.

The non-display region DP-NDA is adjacent to the display region DP-DA. In an embodiment, for example, the non-display region DP-NDA may surround the display region DP-DA. However, this is illustrated as an example, and the non-display region DP-NDA may be defined in various shapes, and is not limited to any one embodiment. In addition, the display panel DP may include a non-display bending portion NDA-BP disposed on at least one side of the non-display region DP-NDA. The non-display bending portion NDA-BP may be disposed to be bent to a lower side of the display module DM to at least partially overlap the display panel DP. A circuit layer, a connection line, a circuit substrate or the like for displaying an image or receiving/sending information may be mounted on or attached to the non-display bending portion NDA-BP.

In an embodiment, the display panel DP includes a display layer EDL. The display layer EDL may be a configuration that substantially generates an image. The image generated by the display layer EDL may be viewed to a user from the outside through the first display surface FS (see FIG. 2A). The display layer EDL may be a light-emitting display layer, but is not specially limited. In an embodiment, for example, the display layer EDL may be an organic or an inorganic light-emitting display layer. The organic light-emitting display layer may include a light-emitting element including an organic light-emitting material in a light-emitting layer thereof. In addition, the inorganic light-emitting display layer may include a light-emitting element including a material such as a quantum dot and a quantum rod in a light-emitting layer thereof.

The display panel DP may further include a sensor layer ISL. The sensor layer ISL may be directly disposed on the display layer EDL. The sensor layer ISL may include a plurality of sensing electrodes. The sensor layer ISL may sense an external input in a self-capacitance manner or a mutual-capacitance manner. The sensor layer ISL may sense an input of an active type input unit.

In an embodiment, for example, the sensor layer ISL may be directly formed on the display layer EDL in a continuous process during manufacturing of the display layer EDL. However, an embodiment of the invention is not limited thereto, and the sensor layer ISL may be manufactured as a separate panel from the display layer EDL to be attached to the display layer EDL by an adhesive layer (not shown).

In an embodiment, the display panel DP may further include an optical layer ROL. The optical layer ROL may serve to reduce reflection by external light. In an embodiment, for example, the optical layer ROL may include a polarization layer or a color filter layer. However, an embodiment of the invention is not limited thereto, and the optical layer ROL may include optical members for improving a display quality of the display module DM.

The optical layer ROL according to an embodiment may be directly disposed on the sensor layer ISL. In an embodiment where the sensor layer ISL is omitted in the display panel DP, the optical layer ROL may be directly disposed on the display layer EDL. However, an embodiment of the invention is not limited thereto, and the optical layer ROL may be disposed on the display layer EDL or the sensor layer ISL by using a separate adhesive member.

The display panel DP may include a folding display portion FP-D and non-folding display portions NFP1-D and NFP2-D. The folding display portion FP-D may correspond to the folding region FA1 (see FIG. 2A), and the non-folding display portions NFP1-D and NFP2-D may correspond to the non-folding regions NFA1 and NFA2 (see FIG. 2A). The folding display portion FP-D and the non-folding display portions NFP1-D and NFP2-D of the display panel DP may be respectively referred to as a folding display portion and non-folding display portions of the display module DM.

The folding display portion FP-D may correspond to a part foldable or bendable with respect to the folding axis FX1 (see FIG. 2A). The display panel DP may include a first non-folding display portion NFP1-D and a second non-folding display portion NFP2-D, and the first non-folding display portion NFP1-D and the second non-folding display portion NFP2-D may be spaced apart from each other in the first directional axis DR1 with the folding display portion FP-D therebetween. The folding display portion FP-D may be a part corresponding to the folding region FA1 of the electronic device ED, and the first non-folding display portion NFP1-D and the second non-folding display portion NFP2-D may be parts respectively corresponding to the first non-folding region NFA1 and the second non-folding region NFA2 of the electronic device ED.

In an embodiment, the support plate MP may be disposed on a lower side of the display panel DP. The support plate MP may include a folding support portion FP-MP and non-folding support portions NFP1-MP and NFP2-MP. The first non-folding support portion NFP1-MP and the second non-folding support portion NFP2-MP of the support plate MP may be spaced apart from each other in the first directional axis DR1 with the folding support portion FP-MP therebetween. The folding support portion FP-MP may correspond to the folding region FA1 (see FIG. 2A), and the non-folding support portions NFP1-MP and NFP2-MP may correspond to the non-folding regions NFA1 and NFA2 (see FIG. 2A). The support plate MP may include a pattern portion PTA in which a plurality of openings OH are defined. The pattern portion PTA may be included in the folding support portion FP-MP. The pattern portion PTA may be disposed corresponding to the folding region FA1 to improve folding or bending characteristics of the electronic device ED.

The protective layer PF of the lower module LM in the display module DM according to an embodiment may be disposed between the display panel DP and the support plate MP. The protective layer PF may be disposed on a lower side of the display panel DP to protect a rear surface of the display panel DP. The protective layer PF may entirely overlap the display panel DP. The protective layer PF may include a polymer material. In an embodiment, for example, the protective layer PF may be a polyimide film or a polyethylene terephthalate film. However, this is merely an example, and a material of the protective layer PF is not limited thereto.

In an embodiment, the lower module LM may include the support member SP. The support member SP may include support layers SP1 and SP2. The support layers SP1 and SP2 may include a first support layer SP1 and a second support layer SP2 spaced apart from each other in the first directional axis DR1. The first support layer SP1 and the second support layer SP2 may be spaced apart from each other in a part corresponding to the first folding axis FX1 (see FIG. 2A). The support layers SP1 and SP2 may be spaced apart from each other in the folding region FA1 and may be provided as the first support layer SP1 and the second support layer SP2 to improve folding or bending characteristics of the electronic device ED. Meanwhile, although not shown, the support layers SP1 and SP2 may further include components of a cushion layer (not shown) and a lower support plate (not shown) stacked in a thickness direction.

The electronic device ED according to an embodiment may further include the digitizer module DTM disposed on a lower side of the support plate MP. The digitizer module DTM according to an embodiment may include components of a digitizer layer, a blocking layer, and the like. The digitizer module DTM may be included as a component of the lower module LM.

The digitizer module DTM may include a first digitizer module DTM1 and a second digitizer module DTM2 disposed spaced apart from each other in a part overlapping the folding region FA1. The first digitizer module DTM1 may be disposed corresponding to the first non-folding region NFA1, and the second digitizer module DTM2 may be disposed corresponding to the second non-folding region NFA2.

That is, in an embodiment, the first digitizer module DTM1 and the second digitizer module DTM2 may be spaced apart from each other in a region overlapping the folding display portion FP-D. The first digitizer module DTM1 may overlap the first non-folding display portion NFP1-D, and the second digitizer module DTM2 may overlap the second non-folding display portion NFP2-D.

In addition, the electronic device ED according to an embodiment may include at least one adhesive layer AP1, AP2, AP3 or AP4. In an embodiment, for example, a first adhesive layer AP1 may be disposed between the display panel DP and the protective layer PF, and a second adhesive layer AP2 may be disposed between the protective layer PF and the support plate MP. A third adhesive layer AP3 and a fourth adhesive layer AP4 may be disposed between the support plate MP and the support member SP. At least one adhesive layer AP1, AP2, AP3 or AP4 may be an optical transparent adhesive film or an optical transparent adhesive resin layer. However, an embodiment of the invention is not limited thereto, and at least one adhesive layer AP1, AP2, AP3 or AP4 may be an adhesive layer having low transmittance of about 80% or less.

FIGS. 5, 6 and the like illustrate an embodiment where the protective layer PF, the support plate MP, the support member SP, the adhesive layers AP1, AP2, AP3 and AP4 and the digitizer module DTM are included in the lower module LM, but an embodiment of the invention is not limited to what is illustrated, and some of components listed in consideration of a mechanical property, a shape, operation characteristics and the like required in the electronic device ED may be selected as components of the lower module LM, or other components except for the proposed components of the lower module may be added.

The electronic device ED according to an embodiment includes the window module WM disposed on the display module DM. The window module WM may include a folding portion FP-W and non-folding portions NFP1-W and NFP2-W. The first non-folding portion NFP1-W and the second non-folding portion NFP2-W of the window module WM may be spaced apart from each other in the first directional axis DR1 with the folding portion FP-W therebetween. The folding portion FP-W may correspond to the folding region FA1 of the electronic device ED (see FIG. 2A), and the non-folding portions NFP1-W and NFP2-W may correspond to the non-folding regions NFA1 and NFA2. In addition, the folding portion FP-W may correspond to the folding display portion FP-D, and the non-folding portions NFP1-W and NFP2-W may correspond to the non-folding display portions NFP1-D and NFP2-D.

The window module WM may entirely cover an upper surface of the display module DM. In an embodiment, the window module WM may be used as a cover window of the electronic device ED. In an embodiment, the window module WM may correspond to an uppermost member of the electronic device ED.

In an embodiment, the window module WM may include a window WP and a resin layer RL. The resin layer RL may be disposed on an upper surface or a lower surface of the window WP. In the disclosure, embodiments where the resin layer RL is disposed on the lower surface of the window WP are illustrated, but an embodiment of the invention is not limited thereto, and the resin layer RL may be disposed on the upper surface of the window WP or may be disposed covering the upper surface and a side surface of the window WP.

In an embodiment, the resin layer RL may include or be formed of an organic resin. In another embodiment, the resin layer RL may include or be formed of a composite resin including all of an organic material and an inorganic material.

In an embodiment, the window WP may be a reinforced glass substrate. The window WP may be an ultra-thin reinforced glass substrate. The window WP may have flexibility of easily changing a state by folding or bending.

In an embodiment, the window WP may include a slimming region having a smaller average thickness than the other region, and the slimming region may be disposed corresponding to the folding region FA1 of the electronic device. FIG. 6 illustrates the electronic device ED including one folding region FA1 as an example, but when a plurality of folding regions are included, the window WP may include slimming regions respectively corresponding to folding regions. The electronic device ED may include the slimming region in the window WP to exhibit improved folding or bending operation characteristics.

The window WP according to an embodiment may be a glass window manufactured with the apparatus for manufacturing a window according to an embodiment to be described later and in the method for manufacturing a window according to an embodiment to be described later.

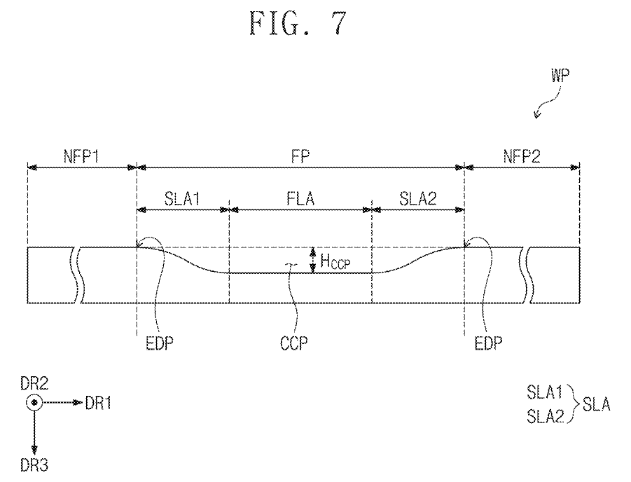

FIG. 7 is a cross-sectional view of a window according to an embodiment. The window WP according to an embodiment may include a folding portion FP and a first non-folding portion NFP1 and a second non-folding portion NFP2 spaced apart from each other in the first directional axis DR1 with the folding portion FP therebetween.

The folding portion FP may include slope regions SLA1 and SLA2 which are adjacent to the non-folding portions NFP1 and NFP2, and have thicknesses that gradually decrease as being toward a center of the folding portion FP in the first direction DR1, and a flat region FLA disposed between the slope regions SLA1 and SLA2. The flat region FLA may have a relatively smaller thickness than the non-folding portions NFP1 and NFP2.

The first slope region SLA1 may be disposed between the first non-folding portion NFP1 and the flat region FLA. The first slope region SLA1 may be a part of which a thickness mildly decreases in a direction away from the first non-folding portion NFP1 to the flat region FLA. The second slope region SLA2 may be disposed between the second non-folding portion NFP2 and the flat region FLA. The second slope region SLA2 may be a part of which a thickness mildly decreases in a direction away from the second non-folding portion NFP2 to the flat region FLA.

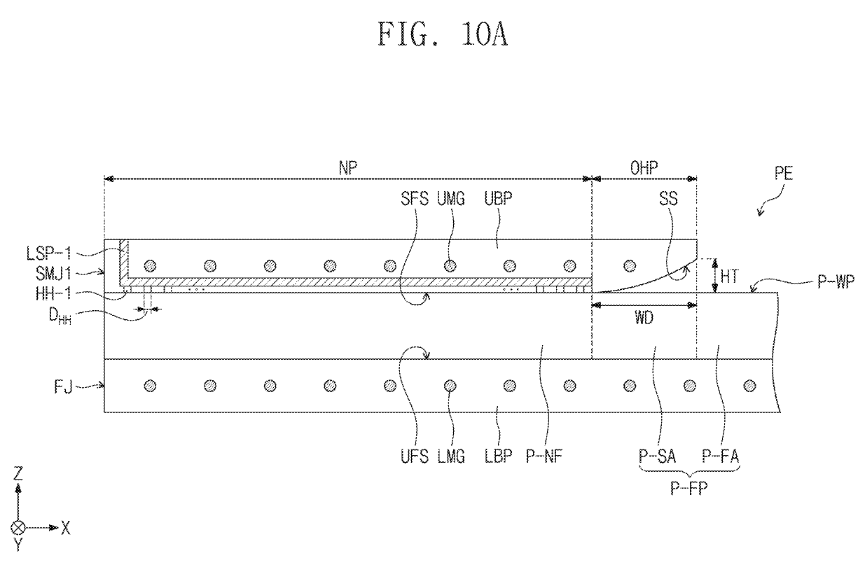

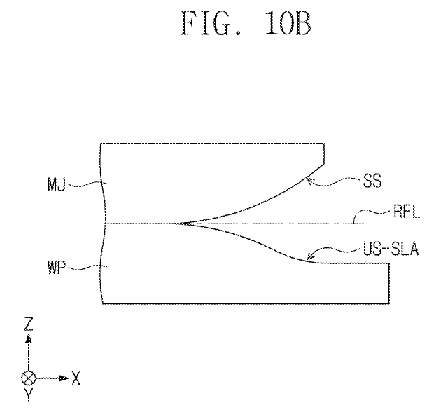

The slope regions SLA1 and SLA2 may be formed by a slope jig portion OHP (see FIG. 10A) of a masking jig MJ in the apparatus for manufacturing a window according to an embodiment to be described later. The slope jig portion OHP (see FIG. 10A) may have a structure of an overhang of which a width gradually decreases from an upper portion to a lower portion. The apparatus for manufacturing a window according to an embodiment will be described later in greater detail.

The folding portion FP may include or define a recessed portion CCP. The recessed portion CCP may be concavely recessed from at least one surface of an upper surface or a lower surface of the window to be formed. The recessed portion CCP may be defined collectively by the slope regions SLA1 and SLA2 and the flat region FLA. A depth H_{CCP} of the recessed portion CCP corresponds to a difference in thicknesses in the third directional axis DR3 of the non-folding portions NFP1 and NFP2 and the flat region FLA. The depth H_{CCP} of the recessed portion CCP may correspond to an etching depth of a preliminary glass when the window is manufactured by etching the preliminary glass in the method for manufacturing a window according to an embodiment by using the apparatus for manufacturing a window according to an embodiment to be described later.

The recessed portion CCP may be formed in a form of extending in the second directional axis DR2 in a plan view or when viewed in the third direction DR3. An extension direction of the recessed portion CCP may correspond to an extension direction of the folding axis FX1 (see FIG. 5). The folding portion FP in which the recessed portion CCP is defined corresponds to a part having a relatively smaller thickness than the first non-folding portion NFP1 and the second non-folding portion NFP2 of the window. The folding portion FP may be referred to as the slimming region.

Referring to FIG. 6, in an embodiment, the window WP may be disposed such that the recessed portion CCP has a shape of being recessed in a direction away farther from an upper surface of the display panel DP, but an embodiment of the invention is not limited thereto, and the window WP may be disposed such that the recessed portion CCP according to an embodiment has a form of being concavely recessed in a direction of the display panel DP.

An edge portion EDP, which is a boundary of the non-folding portions NFP1 and NFP2 and the slope regions SLA1 and SLA2 of the folding portion FP, may correspond to a part, which is a boundary of a flat jig portion NP (see FIG. 10A) and a slope jig portion OHP (see FIG. 10A) in the apparatus for manufacturing a window according to an embodiment to be described later.

In the window WP according to an embodiment, as illustrated in FIG. 7, the recessed portion CCP may be defined only on one surface (an upper surface or lower surface) of the window, but an embodiment of the invention is not limited thereto, and the recessed portion may be defined on all of the upper surface and the lower surface of the window WP according to an embodiment.

FIG. 7 illustrates an embodiment where one surface of the slope region SLA1 or SLA2 defining the recessed portion CCP has a curved surface, but an embodiment of the invention is not limited thereto. One surface of the recessed portion CCP defined in the window WP according to an embodiment may include a curved surface without any discontinuous point, or a smooth slope surface without any discontinuous point. One surface of the slope region SLA1 or SLA2 defining the recessed portion CCP may include a curved surface without any discontinuous point, or a smooth slope surface without any discontinuous point.

One surface of the slope region SLA1 or SLA2 defining the recessed portion CCP may correspond to a shape of a slope jig portion in the apparatus for manufacturing a window according to an embodiment to be described later. One surface of the slope region SLA1 or SLA2 may have a shape symmetrical to a shape of one surface of the slope jig portion.

The recessed portion CCP may be defined by one surface of the flat region FLA. The flat region FLA may have one substantially flat surface. The one surface of the flat region FLA may extend parallel to the non-folding portions NFP1 and NFP2.

In the window WP according to an embodiment, a boundary part between the flat region FLA and the slope regions SLA1 and SLA2 may be naturally connected to each other without any discontinuous part or step so that an upper surface of the recessed portion CCP may have a continuous surface. A window manufactured to have a naturally connected surface without any step may not show a step part or a processed trace to exhibit an improved external appearance quality. In addition, the window manufactured not to have the step part may not show a relatively deteriorated impact-resistance on the step part to exhibit high durability.

A shape of the recessed portion CCP of the window WP according to an embodiment is illustrated in FIG. 7 as an example, and the shape of the recessed portion CCP may be changed according to folding or bending characteristics desired in an electronic device, etc. For example, according to the folding or bending characteristics desired in the electronic device, a radius of curvature or a shape of a curved surface in the slope regions SLA1 and SLA2 having a curved surface shape may be changed. In addition, the slope regions SLA1 and SLA2 may be formed to include a slope surface. According to the folding or bending characteristics desired in the electronic device, widths of the slope regions SLA1 and SLA2, a width of the flat region FLA and a depth of the flat region FLA in the recessed portion CCP may be changed. In addition, a plurality of recessed portions may be defined, and positions at which the recessed portions are defined, or the like may be changed.

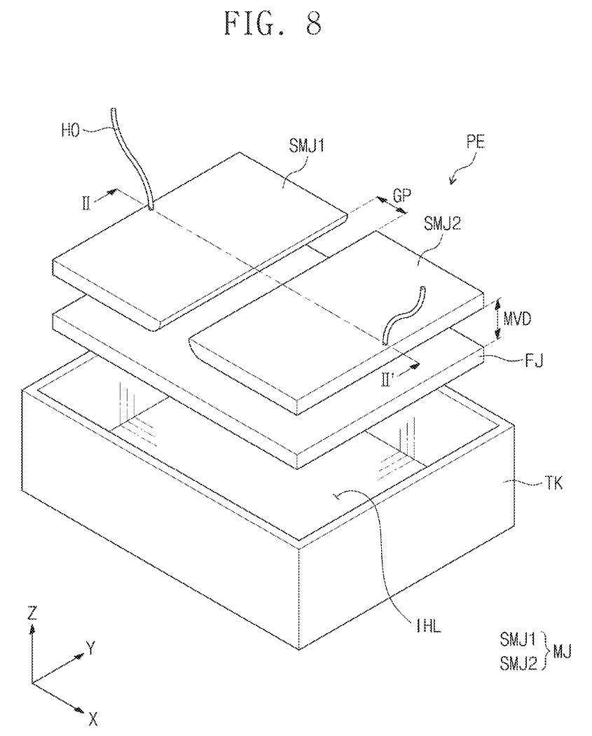

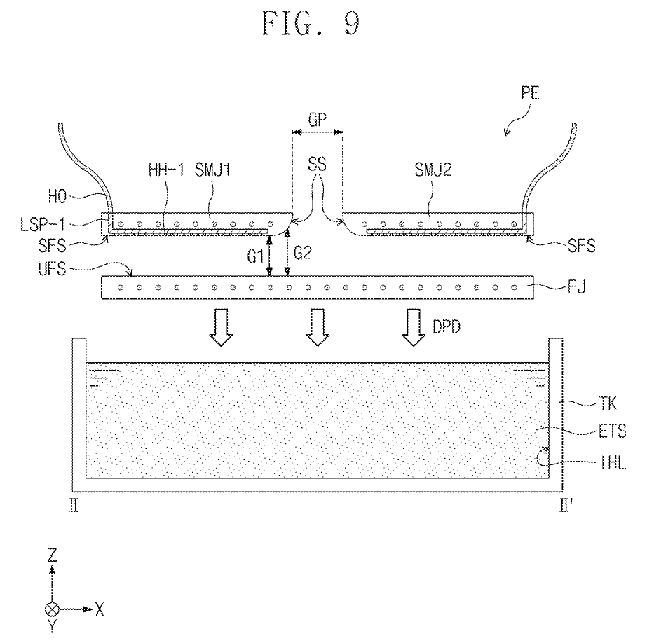

FIG. 8 is a perspective view of an apparatus for manufacturing a window according to an embodiment. FIG. 9 is a cross-sectional view of an apparatus for manufacturing a window according to an embodiment. FIG. 9 may be a cross-sectional view taken along II-II’ of FIG. 8. An apparatus PE for manufacturing a window according to an embodiment includes a fixed jig FJ and a masking jig MJ disposed on the fixed jig FJ.

In addition, the apparatus PE for manufacturing a window according to an embodiment may further include an etchant supply portion TK. The etchant supply portion TK may be disposed on a lower side of the fixed jig FJ. Both the fixed jig FJ and the masking jig MJ may be disposed (e.g., dipped or immersed) in the etchant supply portion TK during a process of manufacturing a window. In the apparatus PE for manufacturing a window according to an embodiment, the fixed jig FJ and the masking jig MJ may move in a dipping direction DPD to be placed in an internal space IHL of the etchant supply portion TK.

The etchant supply portion TK may supply or store etchant during the process of manufacturing a window. Both the fixed jig FJ and the masking jig MJ may be dipped into the internal space IHL of the etchant supply portion TK so that a preliminary glass disposed between the fixed jig FJ and the masking jig MJ may be processed by etchant ETS.

In addition, the apparatus PE for manufacturing a window according to an embodiment may further include a liquid supply portion HO. The liquid supply portion HO may be connected to a first liquid supply tube LSP-1 to serve to provide liquid from the outside to the first liquid supply tube LSP-1. in an embodiment, when both the fixed jig FJ and the masking jig MJ are dipped into the internal space IHL of the etchant supply portion TK, the liquid supply portion HO may serve to block the etchant from infiltrating into the first liquid supply tube LSP-1, and simultaneously to supply only target liquid (for example, ultrapure water). In an embodiment, for example, the liquid supply portion HO may have a form of a hose. The first liquid supply tube LSP-1 will be described later in detail.

Among axis X, axis Y and axis Z illustrated in FIG. 8 and the following drawings, a direction of axis Z is defined as a direction of going toward an upper portion. In addition, axis X and axis Y may be perpendicular to each other, and axis Z may be a normal direction of a plane defined by axis X and axis Y.

Here, axis X may correspond to the first directional axis DR1 illustrated in the drawings described above, axis Y may correspond to the second directional axis DR2 illustrated in the drawings described above, and axis Z may correspond to the third directional axis DR3 illustrated in the drawings described above.

The fixed jig FJ may include a seat surface UFS, or one surface on which a member to be processed is disposed. The seat surface UFS may be a flat surface. In the apparatus PE for manufacturing a window according to an embodiment, the member to be processed may be a glass substrate. In the disclosure, the glass substrate which is the member to be processed before being manufactured as a window is referred to as the preliminary glass.

The masking jig MJ may be disposed on the fixed jig FJ with the preliminary glass therebetween. The fixed jig FJ and the masking jig MJ may be operated and controlled in a moving direction MVD of an up-and-down direction to be adjacent to or spaced apart from each other. In an embodiment, the fixed jig FJ and the masking jig MJ may be operated and controlled such that each of the seat surface UFS of the fixed jig FJ and a flat surface SFS of the masking jig MJ is stuck to one surface of the preliminary glass and is fixed.

The preliminary glass covered by the seat surface UFS of the fixed jig FJ and the flat surface SFS of the masking jig MJ may not be exposed to the etchant ETS to be protected. In an embodiment, the fixed jig FJ and the masking jig MJ may be formed of a material having chemical resistance to the etchant ETS. In an embodiment, the etchant ETS may include a hydrogen fluoride solution, and the fixed jig FJ and the masking jig MJ may include a hydrofluoric acid-resistant material to be formed. In an embodiment, for example, the fixed jig FJ and the masking jig MJ may each independently include polytetrafluoroethylene or polyetheretherketone.

The masking jig MJ may include a first sub mask SMJ1 and a second sub mask SMJ2 spaced apart from each other by a predetermined distance GP. One surface of the sub jig SMJ1 or SMJ2 facing the seat surface UFS of the fixed jig FJ may include a slope or curved surface SS.

The first sub mask SMJ1 and the second sub mask SMJ2 may each include the flat surface SFS facing the seat surface UFS of the fixed jig FJ and flat, and the slope surface SS which gradually increases in a distance G1 or G2 from the seat surface UFS as being away from the flat surface SFS.

Referring to FIGS. 8 and 9, in an embodiment, the first sub mask SMJ1 and the second sub mask SMJ2 may be spaced apart from each other by the first distance GP in a direction of axis X, which is one direction. A part of the first distance GP may correspond to the flat region FLA in the window WP according to an embodiment illustrated and described in FIG. 7. For example, a width in the first directional axis DR1 of the flat region FLA (see FIG. 7) in the window according to an embodiment may correspond to the first distance GP by which the first sub mask SMJ1 and the second sub mask SMJ2 are spaced apart from each other in the apparatus PE for manufacturing a window according to an embodiment.

FIG. 10A is a partially enlarged cross-sectional view of the apparatus for manufacturing a window according to an embodiment in an operational state. FIG. 10B is a schematic diagram illustrating the masking jig in the apparatus for manufacturing a window according to an embodiment and a portion of a window manufactured by using the same.

FIG. 10A illustrates only the first sub mask SMJ1, which is a portion of the masking jig, and only a portion of the fixed jig FJ facing the first sub mask SMJ1, but the same description for a feature of the apparatus for manufacturing a window according to an embodiment described with reference to FIG. 10A may be applied to the second sub mask SMJ2 (see FIG. 9) and the fixed jig FJ facing the same.

The first sub mask SMJ1 includes a flat jig portion NP and a slope jig portion OHP. The flat jig portion NP may include the flat surface SFS facing the seat surface UFS of the fixed jig FJ. The slope jig portion OHP may include the slope surface SS which increases in a distance from the seat surface UFS as extending and being away from the flat surface SFS.

The flat jig portion NP includes the first liquid supply tube LSP-1 and is provided with a plurality of first holes HH-1. The first liquid supply tube LSP-1 may be connected to each of the first holes HH-1 to serve to supply liquid to the first holes HH-1. The first holes HH-1 are opened in a direction toward the flat surface SFS. Accordingly, the first holes HH-1 may serve to emit the liquid outside the first sub mask SMJ1 in the direction toward the flat surface SFS. The liquid may be selected from substances or materials not chemically reacting with the etchant, and not deteriorating an etching function of the etchant. In an embodiment, for example, the liquid may be ultrapure water.

One part of the first liquid supply tube LSP-1 may be disposed parallel to the flat surface SFS. The one part may include a connection portion with the first holes HH-1. One end of the first liquid supply tube LSP-1 may be opened to the outside of the first sub mask SMJ1. FIG. 10A and the like illustrate an embodiment where the one end is opened in a direction toward an upper surface of the first sub mask SMJ1, but an embodiment of the invention is not limited thereto, and the one end may be opened in a direction toward a side surface of the first sub mask SMJ1. In addition, FIG. 10A and the like illustrate an embodiment where the one end of the first liquid supply tube LSP-1 is opened to the outside of the first sub mask SMJ1, but an embodiment of the invention is not limited thereto, and the first liquid supply tube LSP-1 may include a few open portions opened to the outside of the first sub mask SMJ1.

The first liquid supply tube LSP-1 is disposed inside the flat jig portion NP. FIG. 10A and the like illustrate an embodiment where the first liquid supply tube LSP-1 is disposed under a magnet UMG, but an embodiment of the invention is not limited thereto, and the first liquid supply tube LSP-1 may be disposed on the magnet UMG. In addition, FIG. 10A and the like illustrate an embodiment where the first liquid supply tube LSP-1 is disposed overlapping the magnet UMG in a direction of axis Z, but an embodiment of the invention is not limited thereto, and the first liquid supply tube LSP-1 may be disposed not overlapping the magnet UMG in the direction of axis Z. In addition, the flat jig portion NP may include a plurality of first liquid supply tubes LSP-1.

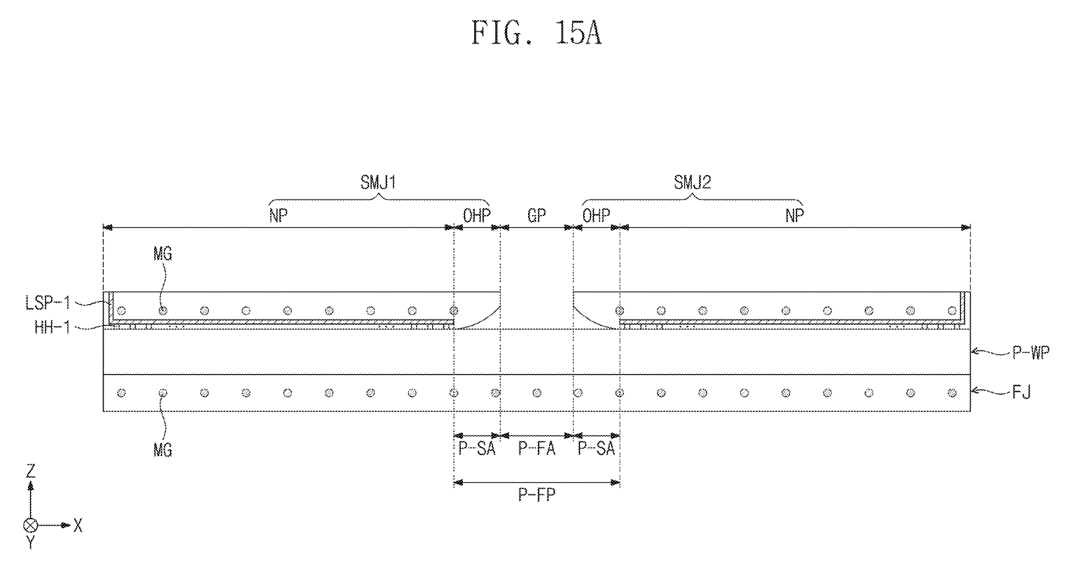

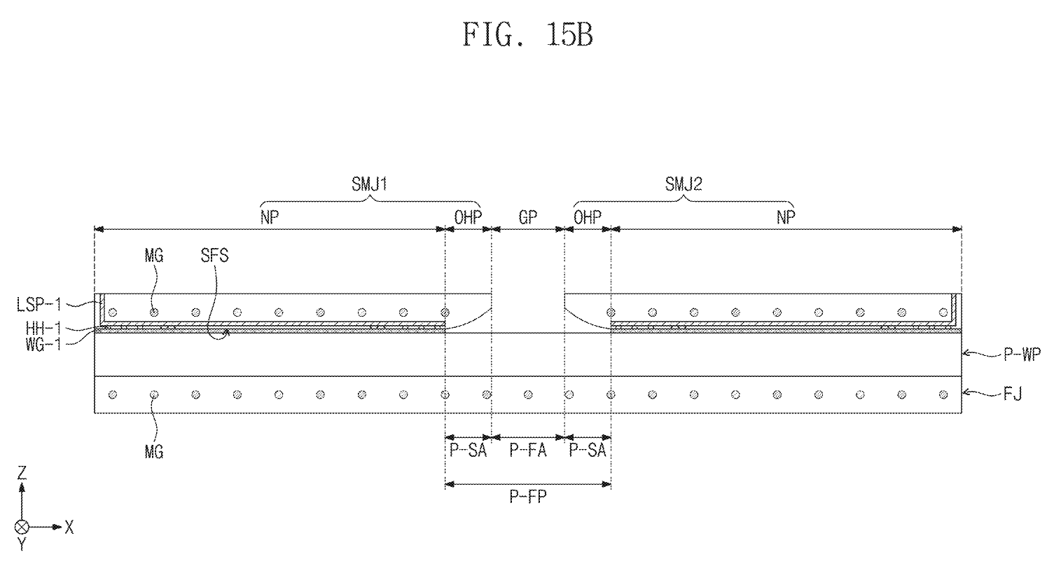

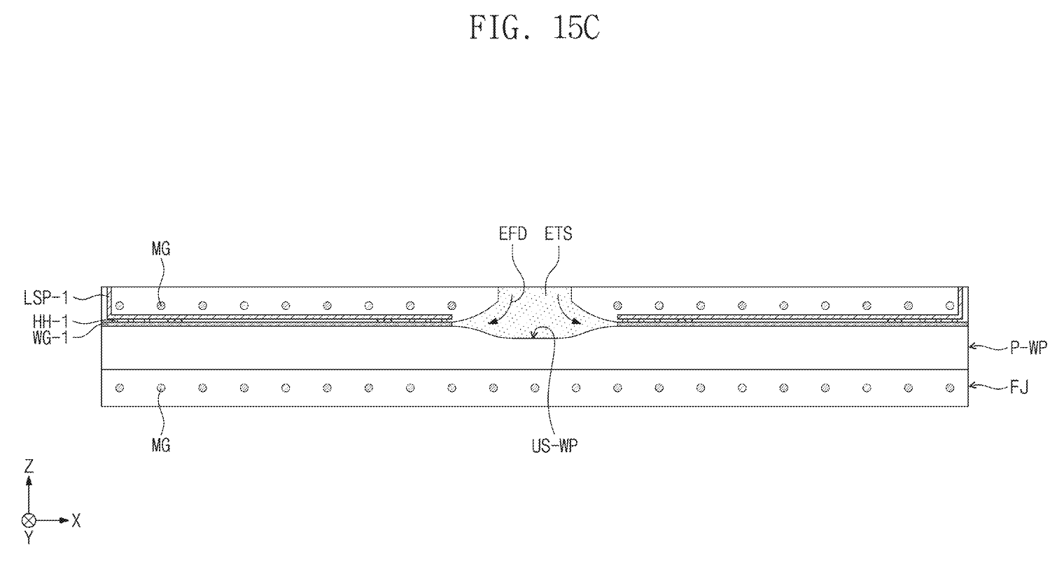

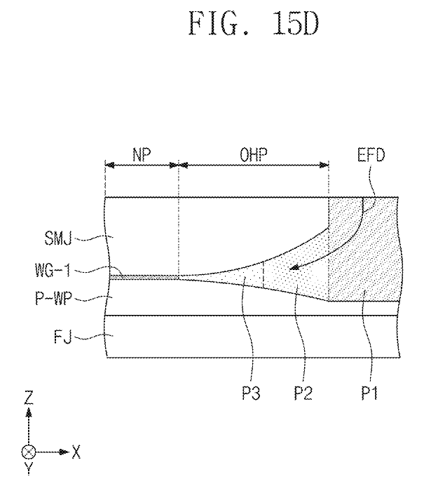

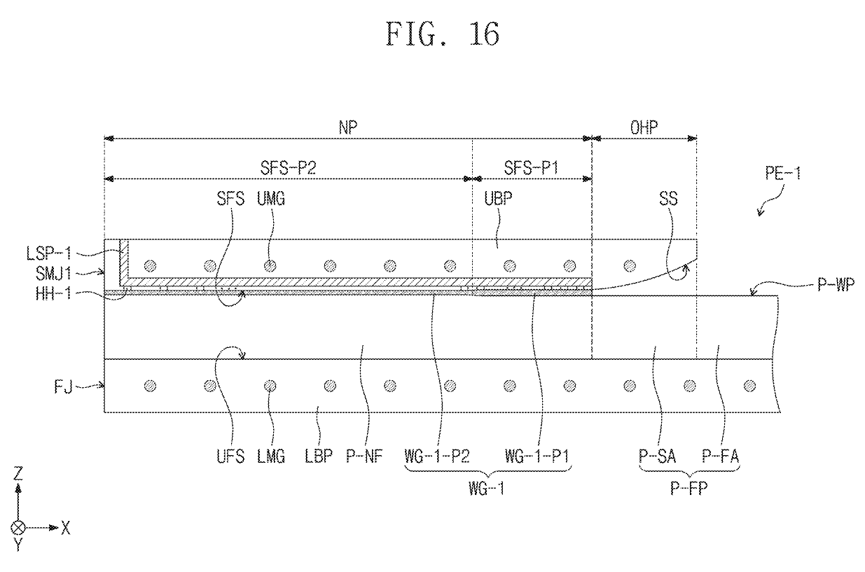

The first holes HH-1 may be connected to the first liquid supply tube LSP-1 on a lower side of the first liquid supply tube LSP-1, and may be opened in a direction toward the flat surface SFS. The first holes HH-1 may be disposed spaced apart from each other in the direction of axis X and the direction of axis Y. The first holes HH-1 may be partially disposed only on the flat surface SFS, or may be entirely disposed on the flat surface SFS. The liquid supplied through the first holes HH-1 by the first liquid supply tube LSP-1 may be emitted in the direction of the flat surface SFS to form a first water film WG-1 (see FIG. 15B) between a preliminary glass P-WP and the flat surface SFS. When the first holes HH-1 are entirely disposed on the flat surface SFS, the first holes HH-1 may entirely or substantially overlap the flat surface SFS to form the first water film WG-1 (see FIG. 15B). The first water film WG-1 (see FIG. 15B) may serve to suppress the etchant from infiltrating between the preliminary glass P-WP and the flat surface SFS during manufacturing the window WP (see FIG. 7) to suppress whitening from occurring on a preliminary glass surface. In addition, the first water film WG-1 (see FIG. 15B) may make the slope regions SLA1 and SLA2 of the window WP (see FIG. 7) have a mild slope surface without an angular part caused by a step, and the like. In the disclosure, a whitening phenomenon means a phenomenon in which a white haze occurs on a surface of the preliminary glass P-WP after etching the preliminary glass P-WP. The white haze may occur due to a remaining etchant component. Accordingly, the white haze may include a fluorine component. For example, the white haze may include ammonium fluoride (NH₄HF₂) or hydrogen fluoride (HF). The first water film WG-1 (see FIG. 15B) will be described later in detail.

In an embodiment, a cross-section of each of the first holes HH-1 may have a shape of a circle on a plane parallel to the flat surface SFS. A diameter D_{HH} of each of the first holes HH-1 may be about 0.1 micrometer (µm) or less. When the diameter D_{HH} of each of the first holes HH-1 exceeds about 0.1 µm, it may be difficult to control a flow rate of the supplied liquid. The first holes HH-1 serve to supply the liquid to form the first water film WG-1 (see FIG. 15B), and a number, lengths in the direction of axis Z, shapes of the cross-sections, and the like of the first holes HH-1 are not specially limited.

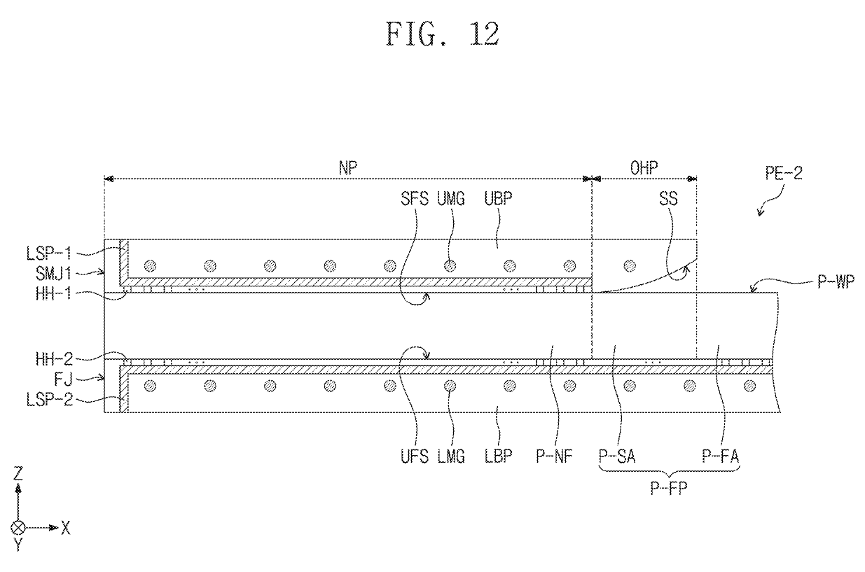

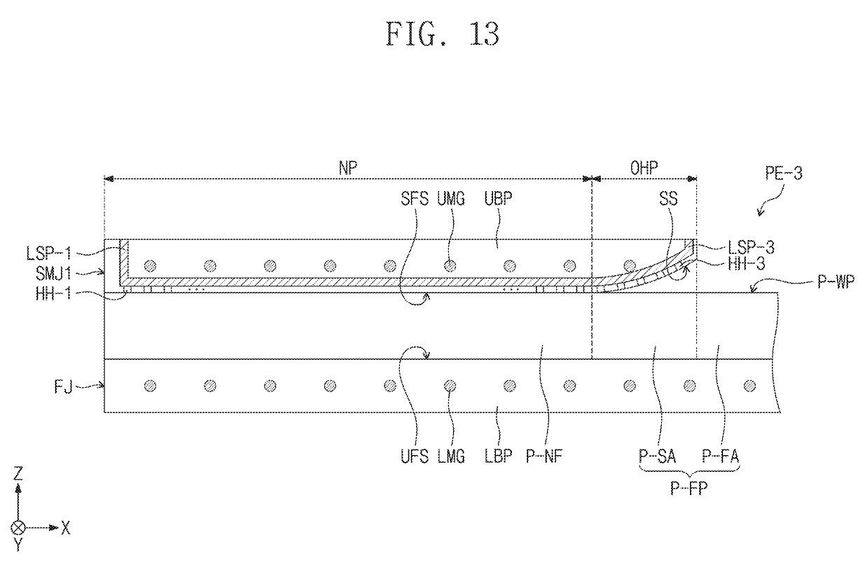

Description on the shape and the like of the first holes HH-1 may be identically applied to second holes HH-2 (see FIG. 12) and third holes HH-3 (see FIG. 13) to be described later. Description on the shape and the like of the first liquid supply tube LSP-1 may be identically applied to a second liquid supply tube LSP-2 and a third liquid supply tube LSP-3 to be described later.

The slope jig portion OHP may have a shape of an overhang on a cross-section defined by axis X and axis Z. The slope jig portion OHP may have a shape in which a width thereof in the direction of axis X gradually increases in the direction of axis Z, which is a thickness direction. Accordingly, a space in the direction of axis Z between the slope jig portion OHP and the preliminary glass P-WP, which is the member to be processed, may increase in the direction of axis X, which is one direction.

The slope surface SS of the slope jig portion OHP may include a slope plane without any discontinuous point, or a slope curved surface having a convex shape in a direction of the fixed jig FJ. The slope surface SS of the slope jig portion OHP may be spaced apart from the preliminary glass P-WP to expose one surface of the preliminary glass P-WP.

The preliminary glass P-WP disposed between the fixed jig FJ and the sub mask SMJ1 may include a preliminary folding portion P-FP and a preliminary non-folding portion P-NF. The preliminary folding portion P-FP may include a preliminary flat region P-FA and a preliminary slope region P-SA.

The preliminary folding portion P-FP may be disposed on a lower side of the slope jig portion OHP, and the preliminary non-folding portion P-NF may be disposed on a lower side of the flat jig portion NP. The preliminary folding portion P-FP may be processed into the folding portion FP (see FIG. 7) in the window according to an embodiment illustrated and described in FIG. 7, and the preliminary non-folding portion P-NF may be processed into the non-folding portions NFP1 and NFP2 (see FIG. 7) in the window according to an embodiment illustrated and described in FIG. 7.

The preliminary slope region P-SA of the preliminary folding portion P-FP may be processed on the lower side of the slope jig portion OHP to form the slope regions SLA1 and SLA2 (see FIG. 7) in the window according to an embodiment illustrated and described in FIG. 7. In addition, the preliminary flat region P-FA of the preliminary folding portion P-FP may be processed in a region by which sub masks are spaced apart from each other to form the flat region FLA (see FIG. 7) in the window according to an embodiment illustrated and described in FIG. 7.

Referring to FIG. 10A, a width WD in the direction of axis X of the slope jig portion OHP may correspond to a width in the direction of axis X of the preliminary slope region P-SA, and a width in one direction of the slope jig portion OHP disposed overlapping the preliminary slope region P-SA may correspond to a width of the slope region SLA1 or SLA2 (see FIG. 7) in the window according to an embodiment illustrated and described in FIG. 7.

In an embodiment illustrated in FIG. 10A, a thickness difference HT in the second directional axis (the direction of axis Z) of one end of the slope jig portion OHP connected to the flat jig portion NP and the other end of the slope jig portion OHP spaced apart from the flat jig portion NP may be about 0.7 millimeter (mm) or less. When the thickness difference HT in the second directional axis (the direction of axis Z) of one end of the slope jig portion OHP connected to the flat jig portion NP and the other end of the slope jig portion OHP spaced apart from the flat jig portion NP is greater than about 0.7 mm, a step between a part disposed on the lower side of the slope jig portion OHP of the preliminary glass P-WP and a part not overlapping the sub mask SMJ1 may not be effectively mild.

In an embodiment, the thickness difference HT in the direction of axis Z of one end of the slope jig portion OHP connected to the flat jig portion NP and the other end of the slope jig portion OHP spaced apart from the flat jig portion NP may be about ten times to about thirty times of the thickness difference H_{CCP} in the third directional axis DR3, which is the thickness direction, of the flat region FLA and the non-folding portions NFP1 and NFP2 in the window WP (see FIG. 7) formed by processing the preliminary glass. In such an embodiment, a mild surface quality may be shown without a step.

FIG. 10A illustrates a state in which the preliminary glass P-WP, which is the member to be processed, is disposed between the masking jig MJ and the fixed jig FJ. The preliminary glass P-WP, which is the member to be processed, may be processed in a state of being fixed between the fixed jig FJ and the sub mask SMJ1 that constitutes the masking jig. The preliminary glass P-WP may be fixed between the fixed jig FJ and the sub mask SMJ1 during forming the recessed portion CCP (see FIG. 7) by etching with the etchant.

In an embodiment, the fixed jig FJ and the sub mask SMJ1 may be fixed facing each other by magnetism. Each of the fixed jig FJ and the sub mask SMJ1 may include a magnet thereinside (or disposed therein).

The fixed jig FJ and the sub mask SMJ1 may respectively include base portions LBP and UBP and magnets LMG and UMG. The base portions LBP and UBP may include a hydrofluoric acid-resistant material having durability with respect to a hydrogen fluoride solution used as the etchant. As described above, the base portions LBP and UBP may include polytetrafluoroethylene or polyetheretherketone.

The magnets LMG and UMG may be disposed in the base portions LBP and UBP. The masking jig MJ (see FIG. 8) and the fixed jig FJ may be fixed in positions close to each other by the magnets LMG and UMG with the preliminary glass P-WP therebetween.

FIG. 10B is a diagram illustrating a shape of the slope jig portion and a shape of the slope region of the window corresponding thereto. A shape of one surface US-SLA of the slope region SLA (see FIG. 7) of the window WP manufactured with the apparatus for manufacturing a window according to an embodiment may be manufactured as a symmetrical shape corresponding to a shape of the lower surface SS of the slope jig portion OHP (see FIG. 10A) of the masking jig MJ. The shape (or a cross-sectional shape) of the one surface US-SLA of the slope region SLA (see FIG. 7) of the window WP and the shape (or a cross-sectional shape) of the lower surface SS of the slope jig of the masking jig MJ may be substantially symmetrical to each other with respect to an imaginary reference line RFL.

FIG. 10B illustrates an embodiment where the lower surface SS of the masking jig MJ has a curved surface convex downward, and the upper surface US-SLA of the window WP manufactured symmetrical thereto has a curved surface convex upward. However, this is an ideally processed form, and the shape of the slope region of the window WP may be controlled by controlling the shape of the lower surface SS of the masking jig.

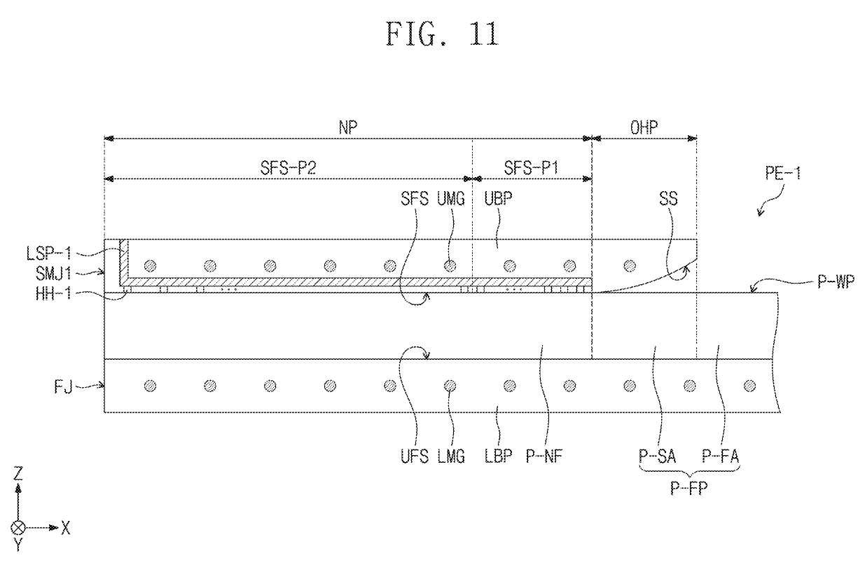

FIGS. 11-13 are cross-sectional views of a part of an apparatus for manufacturing a window according to an embodiment, respectively.

Referring to FIG. 11, in an apparatus PE-1 for manufacturing a window according to an embodiment, the flat surface SFS may include a first flat portion SFS-P1 next to the slope surface SS and a second flat portion SFS-P2 spaced apart from the slope surface SS. In the apparatus PE-1 for manufacturing a window according to an embodiment, a disposition number of a plurality of first holes HH-1 per unit area (or a density of the plurality of first holes HH-1) in the first flat portion SFS-P1 may be greater than a disposition number of a plurality of first holes HH-1 per unit area (or the density of the plurality of first holes HH-1) in the second flat portion SFS-P2. Accordingly, when the plurality of first holes HH-1 supply liquid in a direction of the flat surface SFS, a thickness of a first first water film WG-1-P1 (see FIG. 16) overlapping the first flat portion SFS-P1 may be greater than a thickness of a second first water film WG-1-P2 (see FIG. 16) overlapping the second flat portion SFS-P2. In this case, since the thick first first water film WG-1-P1 (see FIG. 16) effectively suppresses the etchant from infiltrating into a boundary between the slope surface SS and the flat surface SFS, a whitening phenomenon may be effectively improved.

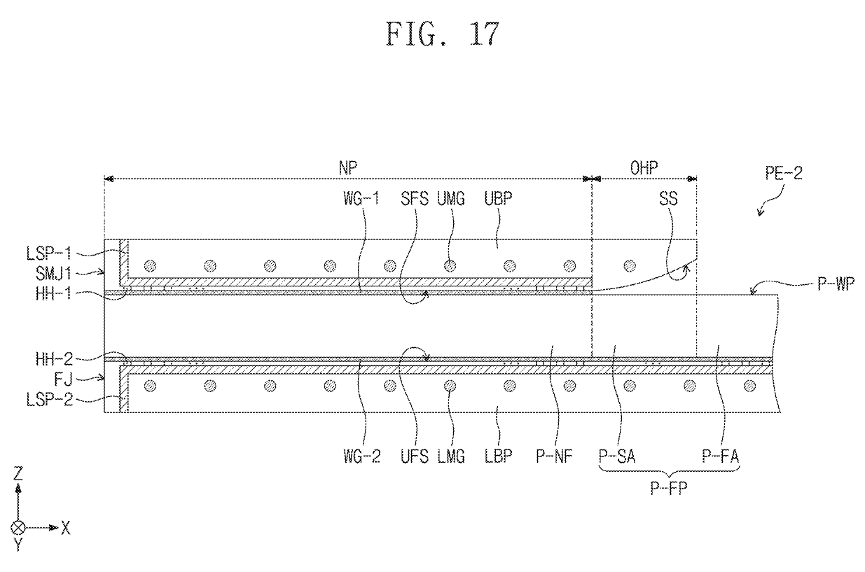

Referring to FIG. 12, in an apparatus PE-2 for manufacturing a window according to an embodiment, the fixed jig FJ may include a second liquid supply tube LSP-2 disposed thereinside, and a plurality of second holes HH-2 connected to the second liquid supply tube LSP-2, and opened in a direction toward the seat surface UFS. The plurality of second holes HH-2 may be disposed to partially overlap the seat surface UFS, or may be entirely disposed on the seat surface UFS. The plurality of opened second holes HH-2 may supply liquid in the direction of the seat surface UFS to form a second water film WG-2 (see FIG. 17) between the preliminary glass P-WP and the seat surface UFS. The second water film WG-2 (see FIG. 17) may serve to suppress the etchant from contacting with a lower surface of the preliminary glass P-WP during etching process to suppress the whitening phenomenon from occurring on the lower surface of the preliminary glass P-WP.

Referring to FIG. 13, in an apparatus PE-3 for manufacturing a window according to an embodiment, the slope jig portion OHP may include a third liquid supply tube LSP-3 disposed thereinside, and a plurality of third holes HH-3 connected to the third liquid supply tube LSP-3, and opened in a direction toward the slope surface SS. One part of the third liquid supply tube LSP-3 may be disposed parallel to the slope surface SS. The one part may include a connection portion with the third holes HH-3. In an embodiment, the third liquid supply tube LSP-3 may be connected to the first liquid supply tube LSP-1 inside the first sub mask SMJ1. In such an embodiment where the first liquid supply tube LSP-1 and the third liquid supply tube LSP-3 are connected to each other, the first holes HH-1 and the third holes HH-3 may simultaneously supply liquid.

In another embodiment, the first liquid supply tube LSP-1 and the third liquid supply tube LSP-3 may not be connected to each other. In such an embodiment, the third liquid supply tube LSP-3 may be provided with liquid through a separate liquid supply portion from the liquid supply portion HO (see FIG. 9) connected to the first liquid supply tube LSP-1. In such an embodiment where the first liquid supply tube LSP-1 and the third liquid supply tube LSP-3 are not connected to each other, the flow rate of the liquid may be controlled to be different in the first liquid supply tube LSP-1 and the third liquid supply tube LSP-3 to appropriately select a water film formation condition.

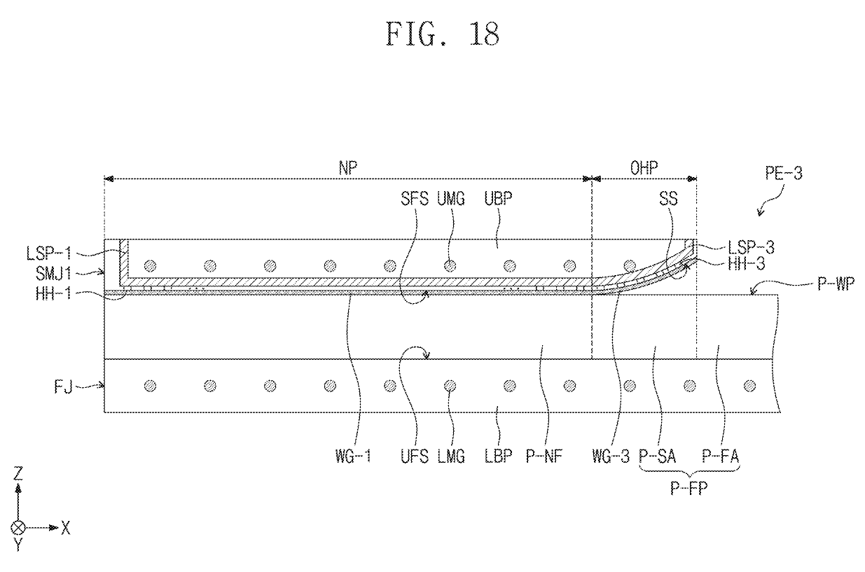

The third holes HH-3 may supply liquid in the direction of the slope surface SS to form a third water film WG-3 (see FIG. 18) between the preliminary glass P-WP and the slope surface SS. The third water film WG-3 (see FIG. 18) may be partially mixed with the etchant to serve to lower a concentration of the etchant in the vicinity of the slope surface SS. The concentration of the etchant in the vicinity of the slope surface SS may be appropriately controlled by controlling an amount of the liquid supplied by the third holes HH-3 to control an etched shape of the preliminary glass P-WP in the vicinity of the slope surface SS. Accordingly, the window improving the whitening phenomenon in the slope region SLA (see FIG. 7) and the flat region FLA (see FIG. 7) and having improved surface characteristics without a step may be manufactured.

The water films WG-1, WG-1-P1, WG-1-P2, WG-2 and WG-3 will be described later in detail.

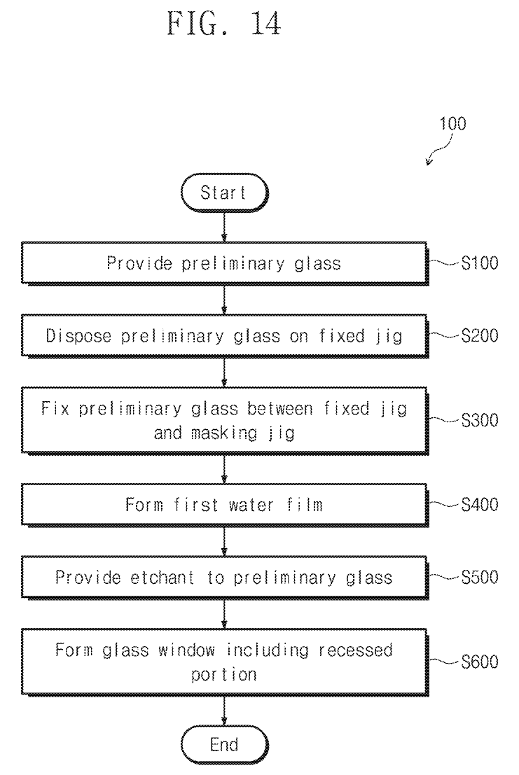

Hereinafter, a method for manufacturing a window according to an embodiment will be described with reference to FIGS. 14-18, etc. In the description of the method for manufacturing the window according to an embodiment, any repetitive detailed description of the same contents as those described with reference to FIGS. 1-13 will be omitted, and differences will be mainly described.

FIG. 14 is a flowchart of the method for manufacturing a window according to an embodiment.

A method (100) for manufacturing a window according to an embodiment includes an operation (S200) of disposing a preliminary glass on a fixed jig, an operation (S300) of fixing the preliminary glass between the fixed jig and a masking jig, an operation (S400) of forming the first water film, an operation (S500) of providing etchant to the preliminary glass and an operation (S600) of forming a glass window including a recessed portion. The method (100) for manufacturing a window according to an embodiment may further include an operation (S100) of providing (or preparing) the preliminary glass.

The method (100) for manufacturing a window according to an embodiment may further include an operation (not shown) of patterning an etching protection film between the operation (S100) of providing the preliminary glass and the operation (S200) of disposing a preliminary glass on a fixed jig. In addition, the method (100) for manufacturing a window according to an embodiment may further include an operation (not shown) of patterning an etching protection film and an operation (not shown) of forming an oxide deposition pattern between the operation (S100) of providing the preliminary glass and the operation (S200) of disposing a preliminary glass on a fixed jig.

FIG. 15A illustrates the operation (S300) of fixing the preliminary glass between the fixed jig and the masking jig. The first sub mask SMJ1 and the second sub mask SMJ2 of the fixed jig may be disposed spaced apart from each other by the first distance GP in a direction of axis X, which is one direction.

The preliminary glass P-WP may be fixed between the fixed jig FJ and the sub masks SMJ1 and SMJ2. A preliminary folding portion P-FP of the preliminary glass P-WP may include a preliminary slope region P-SA processed corresponding to the slope jig portion OHP and a preliminary flat region P-FA processed corresponding to a space between the sub masks SMJ1 and SMJ2.

The first sub mask SMJ1 and the second sub mask SMJ2 of the masking jig MJ may be disposed spaced apart from each other by the first distance. The preliminary glass P-WP may be fixed between two jigs by the magnetism of the magnet MG and may be placed.

FIG. 15B illustrates the operation (S400) of forming the first water film. The first liquid supply tube LSP-1 may supply liquid to the plurality of first holes HH-1 by being supplied with the liquid from the outside of the first sub mask SMJ1. The liquid may be selected from substances or materials not chemically reacting with the etchant, and not deteriorating an etching function of the etchant. In an embodiment, for example, the liquid may be ultrapure water. The plurality of first holes HH-1 may emit the liquid in the direction of the flat surface SFS to form the first water film WG-1 between the preliminary glass P-WP and the flat surface SFS. In an embodiment, the first water film WG-1 may be formed entirely overlapping the flat surface SFS. In another embodiment, the first water film WG-1 may be formed partially overlapping the flat surface SFS as desired. The first water film WG-1 may be formed on the lower side of the second sub mask SMJ2 in the same manner.

When the first water film WG-1 is not present, the etchant may infiltrate between the preliminary glass P-WP and the flat surface SFS and may remain so that the whitening phenomenon may occur on the surface after etching the preliminary glass. In addition, when the distance between the sub mask SMJ and the preliminary glass P-WP is excessively small without the first water film WG-1, the step may occur in the folding portion FP (see FIG. 7) during etching process so that it may be difficult to etch in a mild form. The first water film WG-1 may bring the etchant into sufficient contact with the preliminary folding portion P-FP to be etched and may increase adhesion between the preliminary glass P-WP and the sub mask SMJ to serve to suppress the etchant from infiltrating between the preliminary glass P-WP and the flat surface SFS. The first water film WG-1 may not completely block infiltration of the etchant, and may be partially mixed with the etchant to reduce the concentration of the etchant between the preliminary glass P-WP and the flat surface SFS. Accordingly, the whitening phenomenon occurring due to the etchant remaining between the preliminary glass P-WP and the flat surface SFS may be improved, and the preliminary folding portion P-FP may be etched without the step in the mild form.

A thickness of the first water film is not specially limited, and may be appropriately selected to perform the function described above. The operation (S400) of forming the first water film may be provided before or simultaneously with the operation (S500) of providing etchant to the preliminary glass.

FIG. 15C illustrates the operation (S500) of providing etchant to the preliminary glass. FIG. 15D is an enlarged diagram of the operation (S500) of providing etchant to the preliminary glass.

Referring to FIGS. 15C and 15D, etchant ETS may be provided to the preliminary glass P-WP through a space between the first sub mask SMJ1 and the second sub mask SMJ2 spaced apart from each other.

The etchant ETS may infiltrate between the sub masks SMJ1 and SMJ2 and the preliminary glass P-WP and may be supplied. FIG. 15C illustrates an example of a flow direction EFD of the etchant ETS. The operation of providing etchant according to an embodiment may be processed by performing an operation of fixing the preliminary glass between the fixed jig and the masking jig, and dipping all of the masking jig and the fixed jig having a form in which the preliminary glass is fixed into the etchant. In an embodiment, for example, the masking jig and the fixed jig disposed with the preliminary glass therebetween may be dipped into the internal space IHL (see FIG. 8) of the etchant supply portion TK (see FIG. 8) filled with the etchant. The liquid supply portion HO (see FIG. 8) may be connected to the first liquid supply tube LSP-1 to serve to block the etchant from infiltrating into the first liquid supply tube LSP-1, and to simultaneously supply only the target liquid (for example, ultrapure water).

The etchant ETS may be provided to the preliminary glass P-WP exposed on the lower side of the slope surface of the sub masks through the space between the first sub mask SMJ1 and the second sub mask SMJ2 of the masking jig. The etchant ETS may be provided to an upper surface US-WP of the preliminary glass P-WP to at least partially etch and remove the upper surface US-WP.

The flow direction EFD of the etchant may be from the space between the first sub mask SMJ1 and the second sub mask SMJ2 of the masking jig to the space between the masking jig MJ and the preliminary glass P-WP. Accordingly, the etchant ETS may be provided through the space between the first sub mask SMJ1 and the second sub mask SMJ2 to the space between the slope jig portion OHP and the preliminary glass P-WP. The exposed upper surface US-WP of the preliminary glass P-WP may be sequentially etched along the flow direction EFD of the etchant.

Referring to FIG. 15D, the liquid included in the first water film WG-1 may partially move in a direction of a third point P3 to be mixed with the etchant. The less liquid may arrive at a first point P1 and a second point P2 more spaced apart from the first water film WG-1 than the third point P3 adjacent to the first water film WG-1. That is, a concentration of the liquid may increase in a sequence of the third point P3, the second point P2 and the first point P1 in the space, and a concentration of the etchant may continuously decrease in a direction of the flat surface SFS (see FIG. 15B) in the space. Since based on the concentration of the etchant, an etching effect is the greatest at the first point P1, and the etching effect sequentially decreases in the second point P2 and the third point P3, an upper surface having a mild curved surface may be formed in the slope region SLA (see FIG. 7) without a step and a discontinuous point.

The etchant ETS may include a hydrogen fluoride solution. In an embodiment, for example, the etchant ETS may include ammonium fluoride (NH₄HF₂) or hydrogen fluoride (HF). The fixed jig and the masking jig in the apparatus for manufacturing a window according to an embodiment used in the method for manufacturing a window according to an embodiment may be formed including the hydrofluoric acid-resistant material.

The etchant ETS may infiltrate into the space between the preliminary glass P-WP according to a shape of the slope jig portion OHP of the sub mask SMJ and may be provided, and thus an amount of the etchant ETS provided to the preliminary glass P-WP disposed on the lower side of the slope jig portion OHP may be different. The amount of the etchant ETS provided to the preliminary glass P-WP may be reduced in the direction of the first point P1 to the third point P3 along the flow direction EFD of the etchant ETS. In addition, in an embodiment, time in which the preliminary glass P-WP is exposed to the etchant ETS may be reduced in the direction of the first point P1 to the third point P3 along the flow direction EFD of the etchant ETS.

A difference in how much the preliminary glass P-WP disposed on the lower side is exposed to the etchant ETS (i.e., a difference in amount of exposure of the preliminary glass P-WP disposed on the lower side to the etchant ETS) may occur or be determined based on the shape of an overhang structure of the slope jig portion OHP, and thus the preliminary glass P-WP may be etched to have a shape having a mild slope without a step and a discontinuous point in the preliminary slope region P-SA. In addition, since the preliminary glass P-WP disposed on the lower side of the slope jig portion OHP is continuous with the preliminary glass P-WP not overlapping the masking jig and exposed, the etchant ETS may be continuously provided so that all of the preliminary glass P-WP provided with the etchant ETS may show improved surface characteristics without a processed trace and a step.

In the method for manufacturing a window according to an embodiment, the operation (S600) of forming a glass window may further include an operation of removing the first water film. The operation of removing the first water film may include an operation of removing the liquid remaining on the surface in a method for drying the glass window, or the like. Accordingly, the glass window finally formed may not include the first water film.

The window according to an embodiment manufactured in the method for manufacturing a window according to an embodiment may show an improved whitening phenomenon, high surface quality without a processed trace and a discontinuous point on the entire upper surface of the recessed portion, which is the processed surface, and high durability by forming a mild slope surface without an angular part caused by a step and the like.

FIGS. 16-18 are diagrams illustrating operations of a method for manufacturing a window according to an embodiment, respectively. Description on the apparatus PE-1 for manufacturing a window according to an embodiment provided above with reference to FIG. 11 may be identically applied to FIG. 16. Description on the apparatus PE-2 for manufacturing a window according to an embodiment provided above with reference to FIG. 12 may be identically applied to FIG. 17. Description on the apparatus PE-3 for manufacturing a window according to an embodiment provided above with reference to FIG. 13 may be identically applied to FIG. 18.

Referring to FIG. 16, a disposition number of a plurality of first holes HH-1 per unit area in the first flat portion SFS-P1 may be greater than a disposition number of a plurality of first holes HH-1 per unit area in the second flat portion SFS-P2. Accordingly, a flow rate of the provided liquid per unit area in the first flat portion SFS-P1 may be greater than a flow rate of the provided liquid per unit area in the second flat portion SFS-P2. In the operation (S400) of forming the first water film, when the plurality of first holes HH-1 supply liquid in the direction of the flat surface SFS, the thickness of the first first water film WG-1-P1 overlapping the first flat portion SFS-P1 may be greater than the thickness of the second first water film WG-1-P2 overlapping the second flat portion SFS-P2. Accordingly, the concentration of the etchant infiltrating in the direction of the slope surface SS may be effectively deteriorated by the relatively thick first first water film WG-1-P1. As a result, occurrence of whitening may be effectively reduced so that the window shows high surface quality. The disposition number of the plurality of first holes HH-1 per unit area or the flow rate of the provided liquid per unit area is not specially limited, and may be appropriately selected within a range not deteriorating the etching effect.

Referring to FIG. 17, the fixed jig FJ may include the second liquid supply tube LSP-2 disposed thereinside, and the plurality of second holes HH-2 connected to the second liquid supply tube LSP-2, and opened in the direction of the seat surface UFS. In the method for manufacturing a window according to an embodiment, an operation of forming the second water film WG-2 and the operation (S400) of forming the first water film may be performed in one process operation. The plurality of opened second holes HH-2 may supply liquid in the direction of the seat surface UFS to form the second water film WG-2 between the preliminary glass P-WP and the seat surface UFS. The second water film WG-2 may serve to suppress the etchant from contacting with the lower surface of the preliminary glass P-WP during etching process to suppress the whitening phenomenon from occurring on the lower surface of the preliminary glass P-WP.

Referring to FIG. 18, the slope jig portion OHP may include the third liquid supply tube LSP-3 disposed thereinside, and the plurality of third holes HH-3 connected to the third liquid supply tube LSP-3, and opened in the direction of the slope surface SS. In the method for manufacturing a window according to an embodiment, an operation of forming the third water film WG-3 and the operation (S400) of forming the first water film may be performed in one process operation. The third holes HH-3 may supply liquid in the direction of the slope surface SS to form the third water film WG-3 between the preliminary glass P-WP and the slope surface SS. The third water film WG-3 may be partially mixed with the etchant to serve to lower a concentration of the etchant in the vicinity of the slope surface SS. Accordingly, the concentration of the etchant may continuously increase in a part overlapping the slope surface SS in the direction of axis X, and a visual effect may continuously increase in the part overlapping the slope surface SS in the direction of axis X. Accordingly, an upper surface having a mild curved surface without a step and a discontinuous point may be formed in the slope region SLA (see FIG. 7).

The apparatus for manufacturing a window according to an embodiment may include the fixed jig, the masking jig including the sub masks of which each surface facing the fixed jig has the slope surface, the slope jig portion of which the sub mask has an overhang shape, and the flat jig portion including the first liquid supply tube and the plurality of first holes to be used in manufacturing the window in which occurrence of the whitening phenomenon is reduced, and which has improved surface characteristics without the step in the slope region and the flat region.

The method for manufacturing a window according to an embodiment is a method for manufacturing a window by using the apparatus for manufacturing a window including the flat jig portion including the first liquid supply tube and the plurality of first holes, and the slope jig portion of which the sub mask has the overhang shape, and includes the operation of forming the first water film between the preliminary glass and the flat surface, and the operation of providing the etchant to the preliminary glass disposed on the lower side of the slope jig portion having the overhang shape to manufacture the window having high surface quality by suppressing occurrence of the whitening phenomenon, and having no discontinuous point and processed trace on the entire upper surface of the recessed portion, which is the processed surface. Accordingly, the window manufactured in the method for manufacturing a window according to an embodiment may show improved surface characteristics and may include the mild slope surface without the angular part to show high durability.

Since an apparatus for manufacturing a window according to an embodiment includes a slope jig portion having an overhang shape and a masking jig including a plurality of first holes, a window having improved processing characteristics in a slope region of a recessed portion, and having high surface quality by preventing occurrence of whitening on a surface of the window may be manufactured.

A method for manufacturing a window according to an embodiment includes an operation of forming a first water film on a preliminary glass, and an operation of manufacturing a window by forming the recessed portion on the preliminary glass by using the apparatus for manufacturing a window including the masking jig having an overhang shape in a part corresponding to the slope region, and including a plurality of first holes. Accordingly, the window having a mild shape of the slope region and having improved surface characteristics may be manufactured.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. An apparatus for manufacturing a window, the apparatus comprising:
a fixed jig including a seat surface on which a preliminary glass is disposed; and
a masking jig disposed on the fixed jig, and including a first sub mask and a second sub mask spaced apart from each other in a first direction,
wherein each of the first sub mask and the second sub mask includes:
a flat jig portion having a flat surface facing the seat surface; and
a slope jig portion extending from the flat surface, and having a slope surface, wherein a distance of the slope surface from the seat surface increases in a direction away from the flat surface, and
the flat jig portion includes:
a first liquid supply tube disposed thereinside; and
a plurality of first holes connected to the first liquid supply tube, and opened in a direction toward the flat surface.

2. The apparatus of claim 1, wherein each of the plurality of first holes has a diameter of about 0.1 µm or less.

3. The apparatus of claim 1, wherein the plurality of first holes are entirely disposed on the flat surface.

4. The apparatus of claim 1, wherein the flat surface comprises a first flat portion next to the slope surface and a second flat portion spaced apart from the slope surface, and
a number of the plurality of first holes per unit area in the first flat portion is greater than a number of the plurality of first holes per unit area in the second flat portion.

5. The apparatus of claim 1, wherein the fixed jig comprises:
a second liquid supply tube disposed thereinside; and
a plurality of second holes connected to the second liquid supply tube, and opened in a direction toward the seat surface.

6. The apparatus of claim 1, wherein the slope jig portion comprises:
a third liquid supply tube disposed thereinside; and
a plurality of third holes connected to the third liquid supply tube, and opened in a direction toward the slope surface.

7. The apparatus of claim 1, wherein the slope surface is a slope plane without a discontinuous point, or a slope curved surface having a convex shape in a direction toward the fixed jig.

8. The apparatus of claim 1, wherein the preliminary glass comprises:
a preliminary folding portion disposed on a lower side of the slope jig portion; and
a preliminary non-folding portion disposed on a lower side of the flat jig portion,
the preliminary folding portion is processed to include a flat region, and a first slope region and a second slope region disposed spaced apart from each other in the first direction with the flat region therebetween, and
widths in the first direction of the slope jig portions of the first sub mask and the second sub mask respectively correspond to widths in the first direction of the first slope region and the second slope region in a folding portion formed by slimming-processing of the preliminary glass.

9. The apparatus of claim 1, wherein the masking jig and the fixed jig each comprise a base portion having a hydrofluoric acid-resistant material and a magnet disposed in the base portion, and
the masking jig and the fixed jig are fixed in positions close to each other by the magnet with the preliminary glass therebetween.

10. The apparatus of claim 1, further comprising:
a liquid supply portion connected to the first liquid supply tube; and
an etchant supply portion in which etchant is accommodated and the fixed jig and the masking jig are dipped.

11. A method for manufacturing a window by using an apparatus for manufacturing a window, the apparatus comprising:
a fixed jig; and
a masking jig facing the fixed jig, and including a first sub mask and a second sub mask each including a flat surface and a slope surface, wherein a distance of the slope surface from the fixed jig increases in a direction away from the flat surface, and the first sub mask and the second sub mask are spaced apart from each other with a space therebetween,
wherein the masking jig includes:
a first liquid supply tube disposed to overlap the flat surface; and
a plurality of first holes connected to the first liquid supply tube, and opened in a direction toward the flat surface, and
the method comprising:
disposing a preliminary glass on the fixed jig;
moving the masking jig to fix the preliminary glass between the fixed jig and the masking jig;
providing liquid through the plurality of first holes to form a first water film between the preliminary glass and the flat surface;
providing etchant to the preliminary glass exposed on a lower side of the slope surface and the space between the first sub mask and the second sub mask; and
etching the preliminary glass to form a glass window including a recessed portion defined as a flat region corresponding to the space between the first sub mask and the second sub mask and a slope region corresponding to the slope surface.

12. The method of claim 11, wherein the liquid comprises ultrapure water.

13. The method of claim 11, wherein in the providing the etchant to the preliminary glass, a concentration of the etchant decreases in a direction away from the space between the first sub mask and the second sub mask to the flat surface.

14. The method of claim 11, wherein the flat surface comprises a first flat portion next to the slope surface and a second flat portion spaced apart from the slope surface, and
in the providing liquid through the plurality of first holes, a flow rate of the provided liquid per unit area in the first flat portion is greater than a flow rate of the provided liquid per unit area in the second flat portion.

15. The method of claim 11, wherein the fixed jig comprises:
a seat surface on which the preliminary glass is disposed;
a second liquid supply tube disposed inside the fixed jig; and
a plurality of second holes connected to the second liquid supply tube, and opened in a direction toward the seat surface,
the method further comprising providing the liquid through the plurality of second holes to form a second water film between the preliminary glass and the seat surface,
wherein the providing the liquid through the plurality of first holes and the providing the liquid through the plurality of second holes are simultaneously performed.

16. The method of claim 11, wherein the masking jig comprises:
a third liquid supply tube thereinside to overlap the slope surface; and
a plurality of third holes connected to the third liquid supply tube, and opened in a direction toward the slope surface,
the method further comprising providing the liquid through the plurality of third holes to form a third water film between the preliminary glass and the slope surface,
wherein the providing the liquid through the plurality of first holes and the providing the liquid through the plurality of third holes are simultaneously performed.

17. The method of claim 11, wherein in the providing the liquid through the plurality of first holes, the liquid is supplied through a liquid supply portion connected to the first liquid supply tube.

18. The method of claim 11, further comprising removing the first water film.

19. The method of claim 11, wherein the plurality of first holes are entirely disposed on the flat surface.

20. The method of claim 11, wherein each of the plurality of first holes has a diameter of about 0.1 µm or less.
